(19) United States
(12) Patent Application Publication
(10) Pub. No.: US 2023/0224953 A1
(43) Pub. Date: Jul. 13, 2023

(54) SMALL DATA TRANSMISSION DURING RANDOM ACCESS PROCEDURE FOR NEW RADIO SYSTEMS

(71) Applicant: Intel Corporation, Santa Clara, CA (US)

(72) Inventors: Gang XIONG, Portland, OR (US); Marta MARTINEZ TARRADELL, Hillsboro, OR (US); Seau Sian LIM, Swindon (GB)

(21) Appl. No.: 18/009,297

(22) PCT Filed: Jun. 25, 2021
(86) PCT No.: PCT/US2021/039255

§ 371 Date: Dec. 8, 2022

Related U.S. Application Data
(60) Provisional application No. 63/058,106, filed on Jul. 29, 2020.

(51) Int. Cl. H04W 74/00; H04W 74/08

(52) U.S. Cl. CPC H04W 74/004; H04W 74/0833

(57) ABSTRACT

Various embodiments may relate to small data transmission (SDT), which is also referred to herein as “early data transmission (EDT).” In particular, some embodiments disclosed herein include an indication of transport block size (TBS) and/or modulation and coding scheme (MCS) for Msg3 and/or MsgA PUSCH transmissions, and/or an indication of a fallback mechanism for SDT.

### CROSS REFERENCE TO RELATED APPLICATION

The present application claims priority to U.S. Provisional Patent Application No. 63/058,106, which was filed Jul. 29, 2020.

### FIELD

Various embodiments generally may relate to the field of wireless communications. For example, some embodiments may relate to small data transmission (SDT), which is also referred to herein as “early data transmission (EDT).” In particular, some embodiments disclosed herein include an indication of transport block size (TBS) and/or modulation and coding scheme (MCS) for Msg3 and/or MsgA PUSCH transmissions, and/or an indication of a fallback mechanism for SDT.

### BACKGROUND

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometime conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple and seamless wireless connectivity solutions. NR will enable everything connected by wireless and deliver fast, rich content and services.

### BRIEF DESCRIPTION OF THE FIGURES

FIG. 1 illustrates an example of a 4-step RACH procedure in accordance with various embodiments.

FIG. 2 illustrates an example of a 2-step RACH procedure in accordance with various embodiments.

FIGS. 3A and 3B illustrate examples of RAR UL grants to indicate maximum resources for Msg3 PUSCH transmissions in accordance with various embodiments.

FIG. 4 illustrates an example of a one-to-many mapping between a preamble and PRU for SDT using 2-step RACH in accordance with various embodiments.

FIG. 5 illustrates an example of fallback to 4-step RACH without SDT in accordance with various embodiments.

FIG. 6 illustrates an example of fallback to 4-step RACH with SDT in accordance with various embodiments.

FIG. 7 illustrates an example of an R bit in fallbackRAR indicating fallback to 4-step RACH with and without SDT in accordance with various embodiments.

FIG. 8-1 illustrates an example of an E/T/R/R/BI MAC subheader in accordance with various embodiments.

FIG. 8-2 illustrates an example of an E/T/RAPID MAC subheader in accordance with various embodiments.

FIG. 8-3 illustrates an example of MAC PDU including MAC RARs in accordance with various embodiments.

FIG. 8x-1 illustrates an example of a BI MAC subheader in accordance with various embodiments.

FIG. 8x-2 illustrates an example of a FallbackRAR MAC subheader in accordance with various embodiments.

FIG. 8x-3 illustrates an example of a SuccessRAR MAC subheader in accordance with various embodiments.

FIG. 8a-1 illustrates an example of a BI MAC subheader in accordance with various embodiments.

FIG. 8a-2 illustrates an example of a FallbackRAR MAC subheader in accordance with various embodiments.

FIG. 8a-3 illustrates an example of a SuccessRAR MAC subheader in accordance with various embodiments.

FIG. 8a-4 illustrates an example of MSGB MAC PDU with MAC SDU(s) in accordance with various embodiments.

FIG. 8a-5 illustrates an example of a MSGB MAC PDU without MAC SDU(s) in accordance with various embodiments.

FIG. 9 illustrates a network in accordance with various embodiments.

FIG. 10 illustrates a wireless network in accordance with various embodiments.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein.

FIG. 12 depicts an example procedure for practicing the various embodiments discussed herein.

FIG. 13 depicts another example procedure for practicing the various embodiments.

FIG. 14 depicts another example procedure for practicing the various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

### I. RANDOM ACCESS PROCEDURE ASPECTS

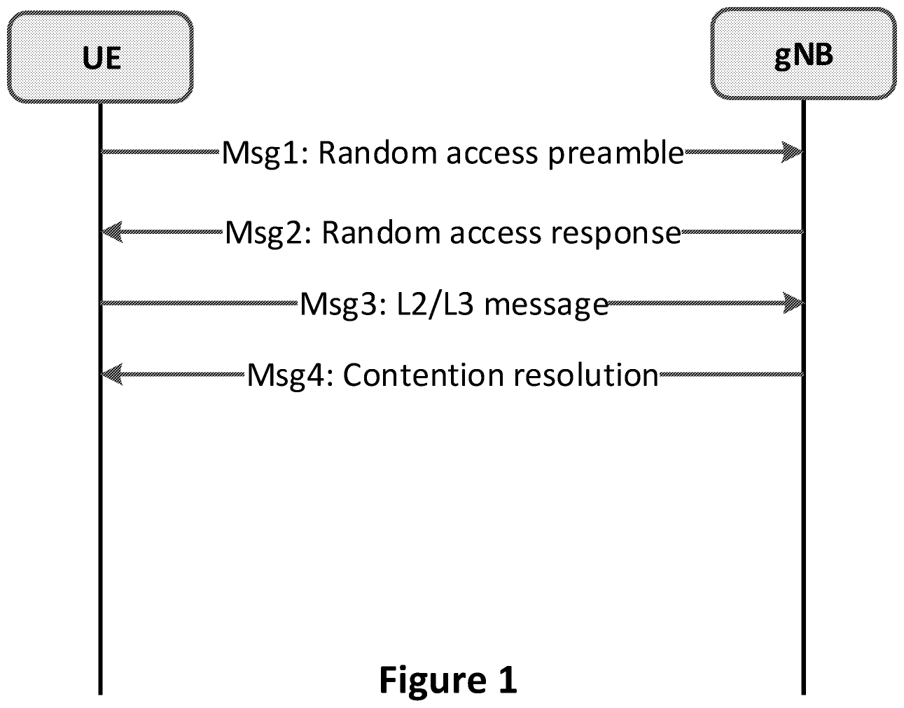

In Rel-15 NR, a 4-step procedure used for initial contention based random access (also referred to as a “random access procedure” or “RACH procedure”) was defined. As illustrated in FIG. 1, in the first step of the 4-step procedure, the UE transmits a physical random access channel (PRACH) in the uplink by selecting one preamble signature (e.g., Msg1: random access preamble in FIG. 1). This allows the gNB to estimate the delay between the gNB and the UE for subsequent UL timing adjustment. The random access preamble is selected/determined and subsequently, in the second step, the gNB feedbacks a random access response (RAR), which carries timing advanced (TA) command information and uplink grant for the uplink transmission. Next, in the third step, the UE transmits an L1/L2 message (e.g., Msg3) over the physical uplink shared channel (PUSCH), which may carry contention resolution ID and/or other information. The Msg3 may be a message transmitted on the UL-SCH containing a C-RNTI MAC CE or CCCH SDU, submitted from upper layer and associated with the UE Contention Resolution Identity, as part of a Random Access procedure. In the fourth step, the gNB sends a contention resolution message (e.g., Msg4) in the physical downlink shared channel (PDSCH).

In Rel-16 NR, a 2-step RACH procedure was defined, with the motivation to allow fast access and low latency uplink transmission. In particular, the 4-step RACH procedure is reduced to 2 steps, where a UE may combine Msg1 and Msg3 in the conventional RACH procedure for low latency PRACH transmission. Further, the 2-step RACH may also be beneficial on the support of mMTC, where MTC devices may simply wake up, transmit the uplink data and go back to sleep using 2-step RACH procedure.

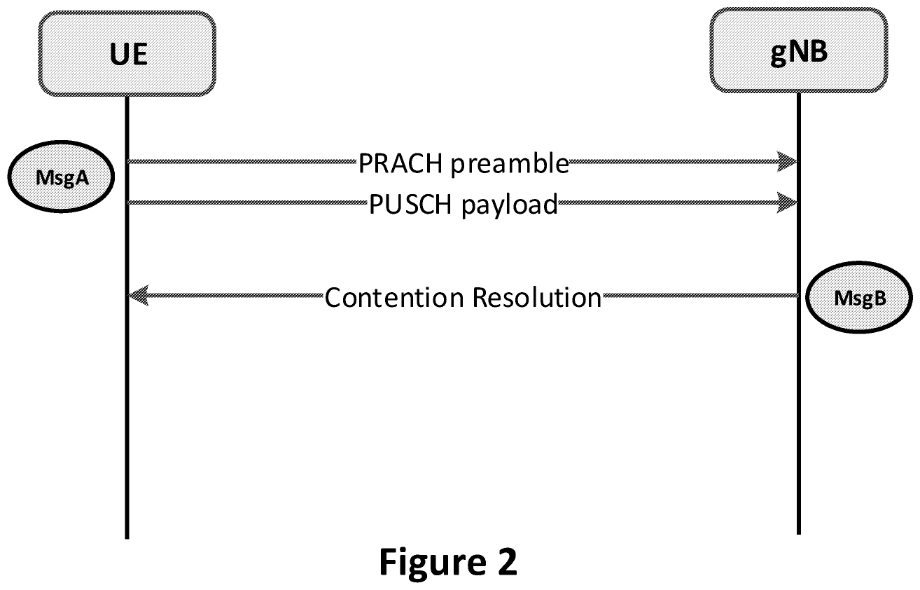

As illustrated in FIG. 2, in the first step, the UE transmits a PRACH preamble and associated MsgA PUSCH on a configured time and frequency resource, where the MsgA PUSCH may carry at least equivalent contents of Msg3 in the 4-step RACH procedure. In the second step, after the gNB successful detects the PRACH preamble and decodes the MsgA PUSCH, the gNB transmits an MsgB that may carry equivalent contents of Msg2 and Msg4 in 4-step RACH procedure.

To optimize the support of infrequent small data transmissions, referred to as early data transmission (EDT) or small data transmission (SDT), amongst other terms, may be employed during random access procedure, which can help reduce data transmission delay and save UE power consumption for UEs in RRC INACTIVE mode. In particular, for 4-step RACH, uplink (UL) and downlink (DL) data transmission may be enabled in Msg3 and Msg4, respectively. Further, for UEs in RRC INACTIVE mode, EDT can be completed without moving into RRC_CONNECTED mode, thereby saving state transition signalling overhead.

For SDT, depending on data traffic, the UE may transmit data on Msg3 with potential different payload size or transport block size (TBS). In order to allow the gNB to successfully decode the Msg3 without substantially increasing the receiver complexity, certain mechanisms may need to be defined for the indication of TBS or modulation and coding scheme (MCS) for Msg3 transmission.

The present disclosure provides embodiments related to SDT during random access procedures for NR systems. In particular, the embodiments herein include:
Indication of transport block size (TBS) and/or modulation and coding scheme (MCS) for Msg.3 and/or MsgA PUSCH transmission; and
Indication of fallback mechanism for SDT.

### II. INDICATION OF TBS AND/OR MCS FOR MSG3 AND/OR MSGA PUSCH TRANSMISSION

As mentioned above, for small data transmission (SDT), depending on the data traffic, a UE may transmit the data on Msg3 with potential different payload size or transport block size (TBS) or considering even other information. That other information may be desirable to consider the diverse NR application/scenarios and may include, for example,
(a) whether data segmentation is or not allowed (which could be understood on whether the gNB allows 1 UL SDT (optionally followed by 1 DL SDT) vs N UL SDT (optionally followed by M DL SDT) with N, M>1),
(b) traffic latency tolerance, and/or
(c) traffic periodicity, etc.

Therefore, this possible information may also take into consideration when creating the different RACH configurations and associated ones, such as, for Msg3/MsgA. For the sake of brevity, the embodiments herein are discussed in terms of the TBS/MCS, however, all possible information are applicable for transmission according to the embodiments herein, even if such information is/are not explicitly mentioned in the following discussion.

In order to allow gNB to successfully decode the Msg3 without substantially increasing receiver complexity, certain mechanisms may need to be defined for the indication of TBS or modulation and coding scheme (MCS) for Msg3 transmission. Embodiments for indication of TBS and/or MCS for Msg3 and/or MsgA PUSCH transmission are provided as follows.

In one embodiment, for EDT during 4-step and/or 2-step RACH procedure, the UE may transmit Msg.3 and/or MsgA PUSCH in accordance with a TBS/MCS from a set of TBS/MCS values which are configured by higher layers via NR remaining minimum system information (RMSI), NR other system information (OSI) or dedicated radio resource control (RRC) signalling. Note that for the set of TBS/MCS values may be configured for preamble group A and B, respectively and UE selects a group in which the set of TBS/MCS values can handle the Msg3/MsgA payload size.

Furthermore, for SDT during 4-step RACH procedure, RAR UL grant may indicate more than one Msg3 PUSCH frequency domain resource allocation (FDRA) and/or time domain resource allocation (TDRA). Based on the indicated MCS, UE may first derive more than one TBSs in accordance with the indicated FDRAs and TDRAs. If the Msg.3 payload size is less than one of the derived TBSs for the FDRA and TDRA (to transmit Msg3), UE would perform zero padding to match with the TBS and select the corresponding FDRA and TDRA for Msg3 PUSCH transmission.

In another embodiment, for SDT during 4-step RACH procedure, RAR UL grant may indicate a single Msg3 PUSCH FDRA and TDRA. Further, MCS field in the UL grant may be reserved, which indicates that UE would ignore this field for Msg3 PUSCH transmission.

For this embodiment, a set of MCS values for Msg3 transmission may be configured by higher layers via minimum system information (MSI), remaining minimum system information (RMSI), other system information (OSI) and/or dedicated radio resource control (RRC) signalling. Note that the set of MCS values can be configured per preamble group A or per preamble group B or both preamble groups A and B, respectively.

Further, based on the indicated FDRA and TDRA in the RAR UL grant, UE can derive a set of TBSs in accordance with the set of MCS values configured by higher layers associated with the preamble group. If the payload size is less than one smallest TBS (denoted as TBS_A), UE would perform zero padding and select the MCS from the set of MCS values which corresponds to TBS_A for the transmission of Msg3 PUSCH.

Table II-1 provides one example of RAR UL grant fields. In the example, MCS field is reserved for SDT with 4-step RACH procedure.

TABLE II-1
Random Access Response Grant Content field size

| RAR grant field | Number of bits |
|---|---|
| Frequency hopping flag | 1 |
| PUSCH frequency resource | 14, for operation without shared |
| allocation | spectrum channel access |
| | 12, for operation with shared |
| | spectrum channel access |
| PUSCH time resource allocation | 4 |
| MCS | 4 (reserved for SDT with Type-1 |
| | random access procedure) |
| TPC command for PUSCH | 3 |
| CSI request | 1 |
| ChannelAccess-CPext | 0, for operation without shared |
| | spectrum channel access |
| | 2, for operation with shared |
| | spectrum channel access |

As a further extension, MCS in RAR grant field for EDT with 4-step RACH procedure may be used to indicate the maximum MCS index that UE can use for Msg3 PUSCH transmission from the set of configured MCS values. In one example, assuming MCS #0 and MCS #3 are configured for SDT with 4-step RACH, when MCS field in the RAR UL grant indicates MCS #3, the UE may select either MCS #0 or MCS #3 for Msg3 transmission, depending on payload size of Msg3. In another example, when MCS field in the RAR UL grant indicates MCS #0, UE can only use MCS #0 for Msg3 transmission.

In another embodiment, for SDT during 4-step RACH procedure, RAR UL grant may be used to indicate a single Msg3 PUSCH FDRA and TDRA, which corresponds to a maximum resource allocation for Msg3 transmission. This also indicates the maximum TBS that can be carried by Msg3 PUSCH, which can be derived in accordance with the indicated FDRA and TDRA resource and MCS.

When a set of TBSs can be used for Msg3 transmission, and when the payload size is less than the one smallest TBS, UE may use indicated MCS and a subset of allocated resource for Msg3 transmission.

In one example, a set of scaling factors can be configured to derive the subset of allocated resource. When scaling factor=0.5, UE may select the half of the number of PRBs for Msg3 transmission. Note that the starting PRB for Msg3 PUSCH transmission may be derived based on the FDRA indicated in the RAR UL grant.

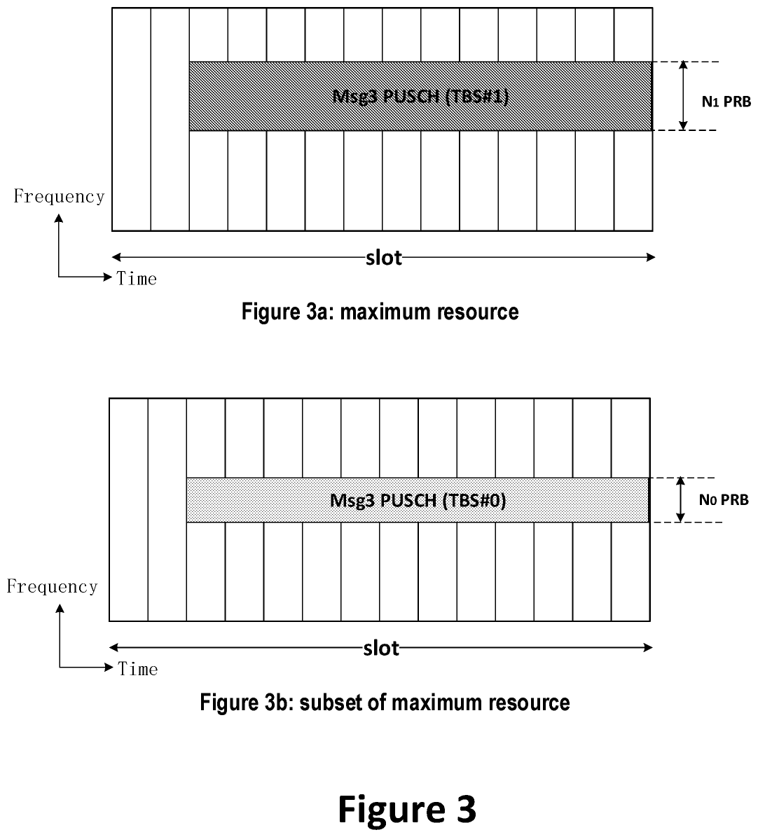

FIGS. 3a and 3b show example RAR UL grants to indicate maximum resource for Msg3 PUSCH transmission. FIGS. 3a and 3b illustrates one example of using RAR UL grant to indicate maximum resource for Msg3 PUSCH transmission. In the example, TBS #0 and TBS #1 can be carried by Msg3 PUSCH and TBS #1 is the maximum TBS (e.g., TBS #0<TBS #1). In the RAR UL grant, gNB may indicate the maximum resource, or N1 PRBs, which corresponds to TBS #1 as shown in FIG. 3a. When payload size is less than TBS #0, UE may perform zero padding, and select a subset of indicated maximum resource, or N2 PRBs for Msg3 transmission, as shown in FIG. 3b. Note that the Msg3 PUSCH transmission starts from the indicated starting PRB in FDRA.

In another embodiment, for SDT with 2-step RACH procedure, when gNB performs fallback mechanism to SDT with 4-step RACH procedure, gNB can use the fallbackRAR UL grant to indicate the MCS and resource for Msg3 transmission. Further, the above embodiments for RAR UL grant can be straightforwardly applied for fallbackRAR UL grant for Msg3 transmission.

In another embodiment, a UE may be configured with more than one DMRS resources for transmission of Msg3 for 4-step RACH and/or MsgA PUSCH for 2-step RACH. The UE may transmit the DMRS in one of the DMRS resources in accordance with the TBS/MCS for Msg3 for 4-step RACH and/or MsgA PUSCH for 2-step RACH.

In one example, assuming a UE is configured with two DMRS resources, when UE transmits DMRS in a first DMRS resource, it can be used to indicate a first TBS/MCS for transmission of Msg3 for 4-step RACH and/or MsgA PUSCH for 2-step RACH. When UE transmits DMRS in a second DMRS resource, it can be used to indicate a second TBS/MCS for transmission of Msg3 for 4-step RACH and/or MsgA PUSCH for 2-step RACH.

Note that a DMRS resource may include DMRS sequence and/or cyclic shifts and/or scrambling IDs and/or DMRS antenna port. In one embodiment, for SDT using 4-step RACH, multiple DMRS ports can be defined for Msg3 transmission. For instance, two DMRS ports can be defined for Msg3 transmission. In this case, DMRS port 0 may be used to indicate a first TBS/MCS for the transmission of Msg3 while DMRS port 1 or 2 may be used to indicate a second TBS/MCS for the transmission of Msg3.

In another embodiment, for EDT using 4-step RACH, when CP-OFDM waveform is configured for the transmission of Msg3, more than one scrambling IDs may be configured for Msg3 transmission by higher layers via RMSI (SIB1), OSI or RRC signalling. In case when two scrambling IDs are configured, a first scrambling ID may be used to indicate a first TBS/MCS for the transmission of Msg3 while a second scrambling ID may be used to indicate a second TBS/MCS for the transmission of Msg3.

In another embodiments, for SDT using 2-step RACH, one to many mapping between MsgA PRACH preamble and PUSCH resource unit (PRU) may be defined. Note that PRU is defined as a MsgA PUSCH occasion associated with a DMRS resource, where MsgA PUSCH occasion is defined by a time and frequency resource for MsgA PUSCH transmission. In case when one to two mapping between MsgA PRACH preamble and PRU is defined, one MsgA PRACH preamble is mapped to two PRUs. Further, a first PRU may be used to indicate a first TBS/MCS for the transmission of MsgA PUSCH while a second PRU may be used to indicate a second TBS/MCS for the transmission of MsgA PUSCH.

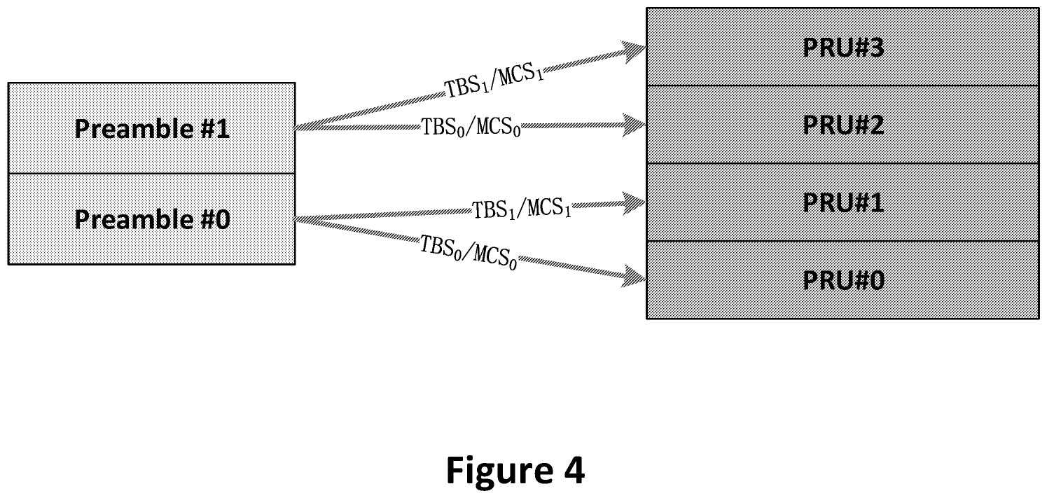

FIG. 4 illustrates one example of one to many mapping between PRACH preamble and PRU for SDT using 2-step RACH. In the example, one to two mapping is assumed. Further, for preamble #0, PRU #0 can be used to indicate a first TBS/MCS for MsgA PUSCH transmission; while PRU #1 can be used to indicate a second TBS/MCS for MsgA PUSCH transmission.

### III. INDICATION OF FALLBACK MECHANISM FOR SDT

For SDT during RACH procedure, when UE initiates SDT request using dedicated PRACH preamble reserved for SDT operation, gNB may fallback the SDT on Msg3 to conventional RACH procedure or fallback the SDT on MsgA to conventional RACH procedure (e.g., in such cases gNB fails to decode the MsgA PUSCH and the SDT Msg3 PUSCH resources are congested). In this case, certain mechanisms may need to be defined on how to indicate the fallback mechanism for SDT for both 2-step and 4-step RACH procedure. Embodiments of indication of fallback mechanism for SDT during RACH procedure are provided as follows:

In one embodiment, for SDT during 4-step RACH procedure, one field in the random access response (RAR) may be repurposed or some states in one or more existing fields in the RAR may be reserved and repurposed to indicate the fallback mechanism from SDT to legacy 4-step RACH procedure. Note that after UE receives RAR with fallback indication, UE would follow conventional RACH procedure and transmit Msg3 without SDT operation (e.g., to resume or establish the connection getting the UE into RRC_CONNECTED).

In one example, if timing advance (TA) command in RAR is set to all ‘1’, and/or if PUSCH frequency resource allocation in RAR UL grant is set to all ‘1’, and/or MCS in RAR UL grant is set to all ‘1’, and/or transmit power control (TPC) command in RAR UL grant is set to all ‘1’, UE may assume fallback to legacy 4-step RACH without SDT operation.

In another example, if channel state information (CSI) request in RAR UL grant is set to ‘1’, UE may assume fallback to legacy 4-step RACH without SDT operation.

In another embodiment, for SDT during 2-step RACH procedure, the UE may transmit MsgA PUSCH in accordance with a TBS/MCS from a set of TBS/MCS values which are configure by higher layers via RMSI (SIB1), OSI or RRC signalling. Note that for the set of TBS/MCS values may be configured for group A and B, respectively.

After the UE transmits the MsgA PUSCH, the gNB may indicate that the UE should fallback to 4-step RACH with and without SDT. This may be for the case when gNB successfully detects PRACH preamble but fails to decode MsgA PUSCH. In particular, if the UE receives the fallbackRAR, the UE may assume that the SDT with 2-step RACH procedure is fall-backed to 4-step RACH. Note that this fallback mechanism may assume the 4-step RACH with or without SDT.

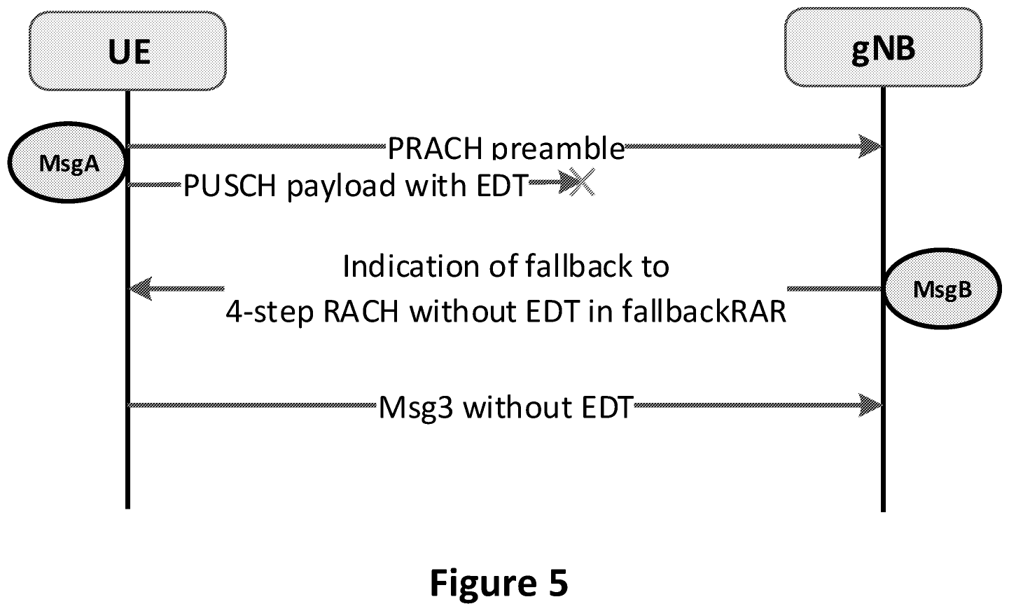

FIG. 5 illustrates an example fallback mechanism to 4-step RACH without SDT for 2-step RACH procedure according to various embodiments. In a first step, the UE transmits both a MsgA PRACH and PUSCH with SDT. When the gNB successfully detects the PRACH preamble, but fails to decode MsgA PUSCH, the gNB may fall back to the 4-step RACH without SDT. In this case, the UE transmits the Msg3 without SDT.

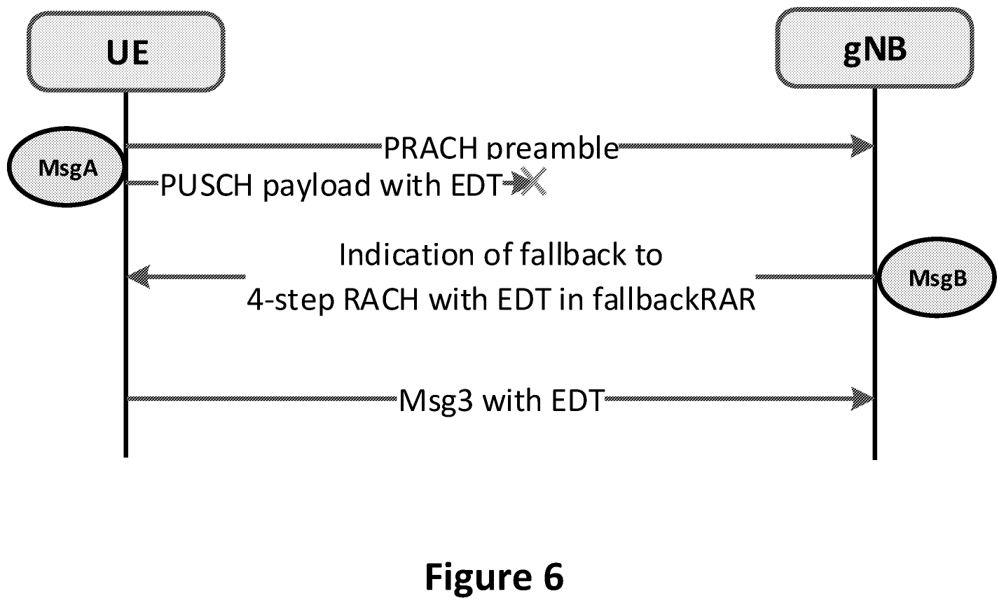

FIG. 6 illustrates an example fallback mechanism to 4-step RACH with SDT for 2-step RACH procedure according to various embodiments. In a first step, the UE transmits both MsgA PRACH and PUSCH with SDT. When gNB successfully detects the PRACH preamble, but fails to decode the MsgA PUSCH, the gNB may fall back to the 4-step RACH with SDT. In this case, the UE transmits the Msg3 with SDT.

In order to inform the fallback decision to the UE, one or more fields in the fallbackRAR may be repurposed or some states in one or more fields in the fallbackRAR may be reserved to indicate the fallback mechanism from SDT using 2-step RACH to 4-step RACH procedure with and without SDT.

In one embodiment, reserved field “R” in the fallbackRAR can be set to ‘1’ indicate the fallback to 4-step RACH with SDT. In this case, the default state or ‘0’ can be used to indicate the fallback to 4-step RACH without SDT. Alternatively, reserved field “R” in the fallbackRAR can be set to ‘1’ indicate the fallback to 4-step RACH without SDT. In this case, the default state or ‘0’ can be used to indicate the fallback to 4-step RACH with SDT.

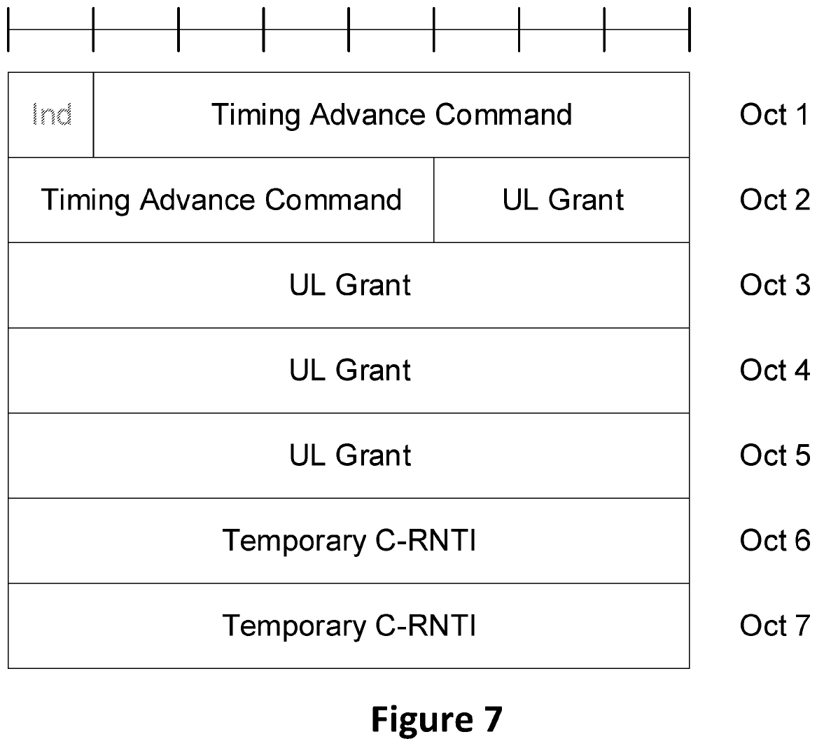

FIG. 7 illustrates an example of using an R bit in fallbackRAR to indicate fallback to 4-step RACH with and without SDT. Note that fallbackRAR is described in Section 6.2.3a in TS 38.321, v. 15.8.0, 202-01-07. In the example, bit ‘1’ can be used to indicate the fallback to 4-step RACH with SDT while bit ‘0’ can be used to indicate the fallback to 4-step RACH without SDT.

In another embodiment, some states in one or more fields in the RAR may be reserved to indicate the fallback to 4-step RACH procedure with or without SDT. Note that the aforementioned embodiments can be employed for the indication. In one example, if TA command in fallbackRAR is set to all ‘1’, and/or if PUSCH frequency resource allocation in fallbackRAR UL grant is set to all ‘1’, and/or MCS in fallbackRAR UL grant is set to all ‘1’, and/or TPC command in fallbackRAR UL grant is set to all ‘1’, UE may assume fallback to legacy 4-step RACH without SDT operation.

In another example, if channel state information (CSI) request in fallbackRAR UL grant is set to ‘1’, UE may assume fallback to legacy 4-step RACH without SDT operation.

In another embodiment, different fallbackRARs can be considered, one for non-SDT (e.g., using the legacy fallbackRAR) and another for SDT (e.g., introducing a new SDT fallback RAR). The differentiation of this can be indicated in the subheader for the RAR as shown by the following figures.

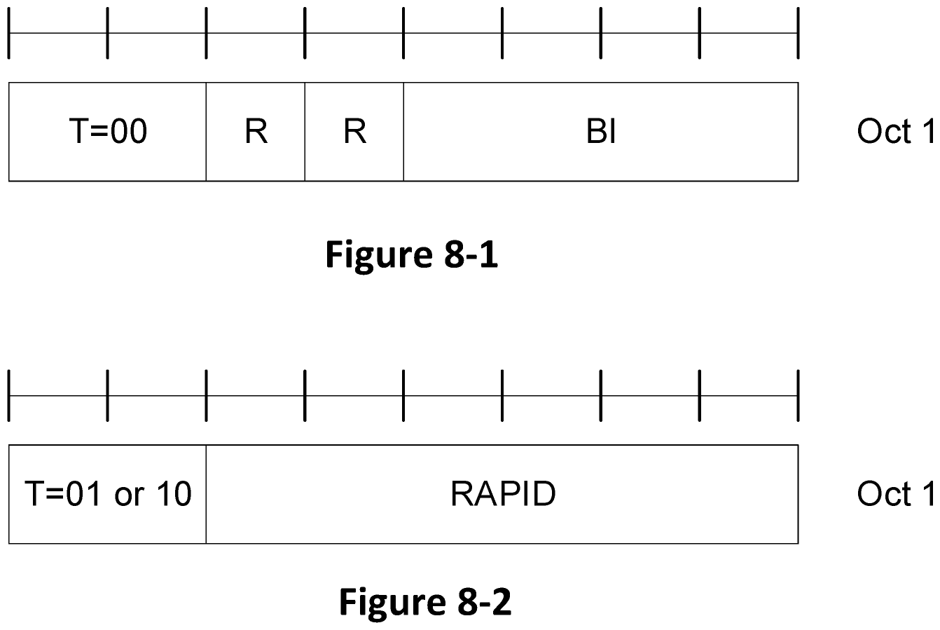

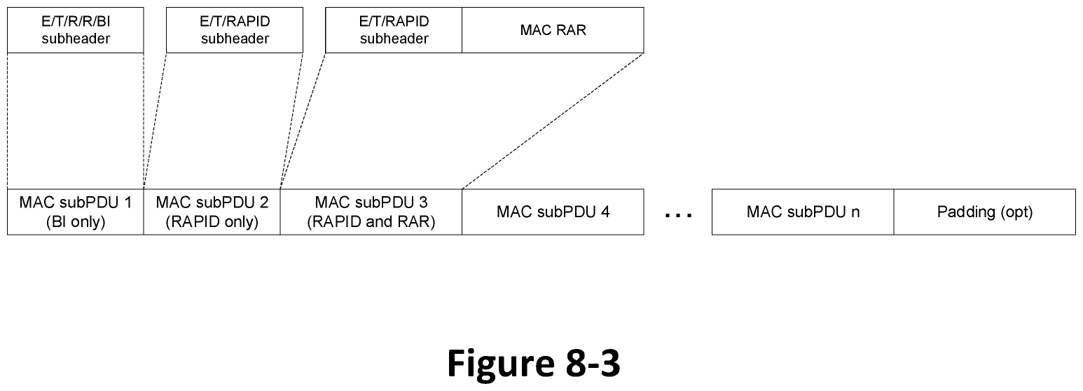

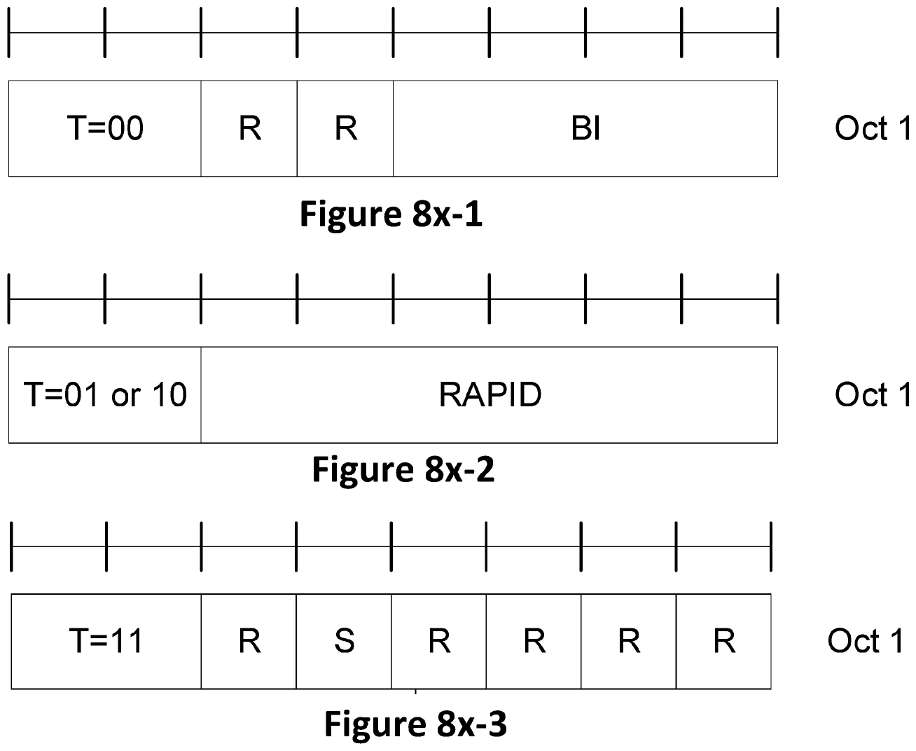

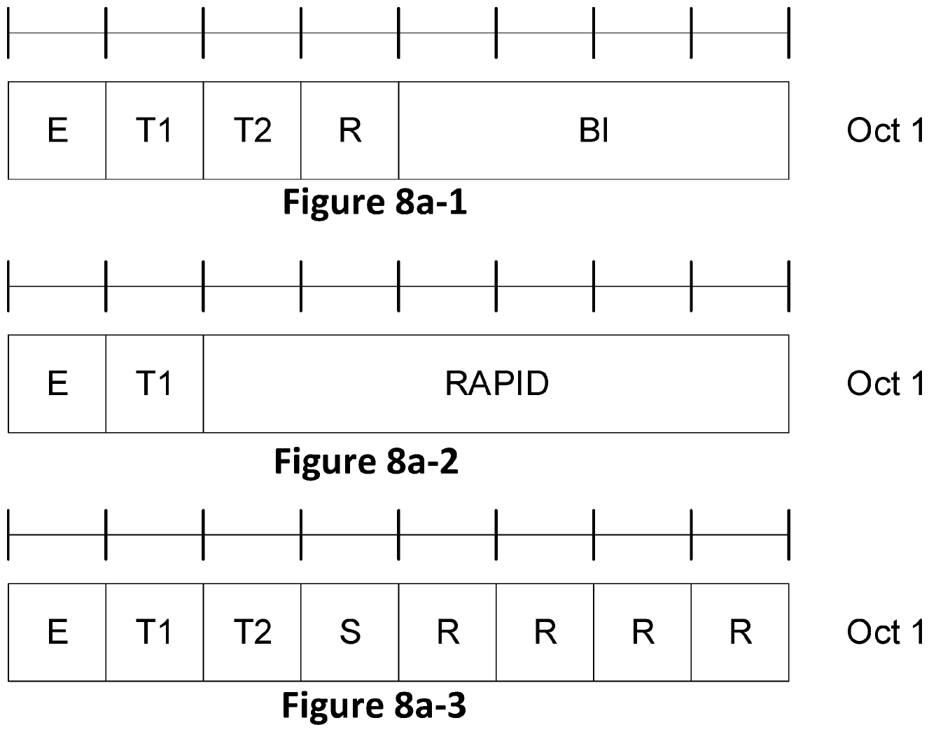

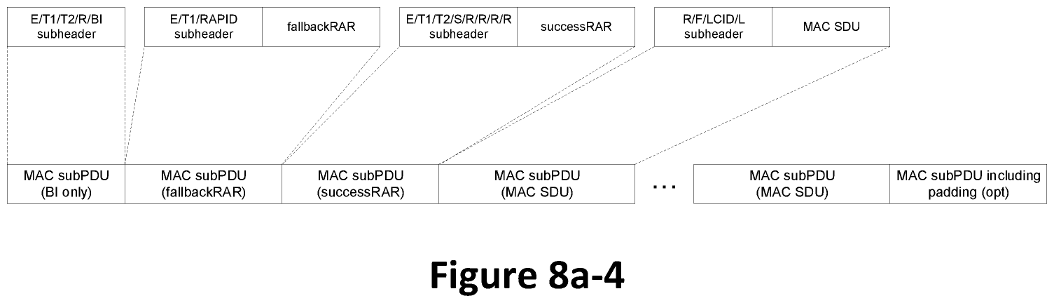

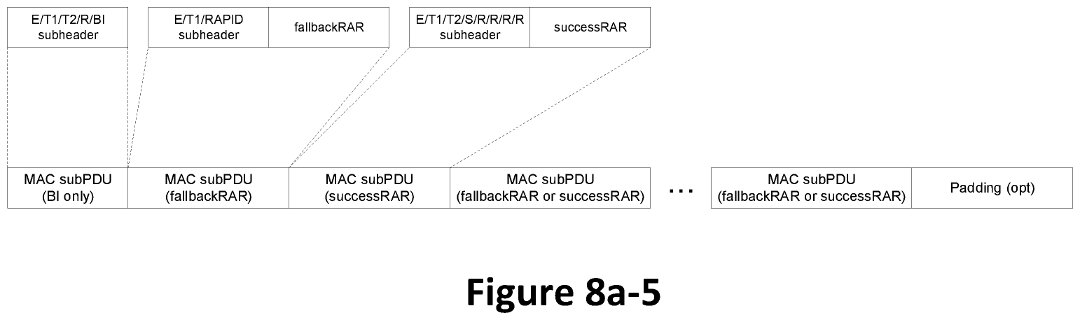

A MAC PDU comprises one or more MAC subPDUs and optionally padding (see e.g., FIG. 8-3). Each MAC subPDU includes one of the following:
a MAC subheader with Backoff Indicator only;
a MAC subheader with RAPID only (i.e. acknowledgment for SI request);
a MAC subheader with RAPID and MAC RAR.

A MAC subheader with Backoff Indicator includes five header fields E/T/R/R/BI as shown by FIG. 8-1. A MAC subheader with RAPID includes three header fields E/T/RAPID as shown by FIG. 8-2.

A MAC subPDU with Backoff Indicator only is placed at the beginning of the MAC PDU, if included. ‘MAC subPDU(s) with RAPID only’ and ‘MAC subPDU(s) with RAPID and MAC RAR’ can be placed anywhere between MAC subPDU with Backoff Indicator only (if any) and padding (if any). Padding is placed at the end of the MAC PDU if present. Presence and length of padding is implicit based on TB size, size of MAC subPDU(s). For 4-step RACH, the RAR PDU contains a subheader as shown by FIG. 8-1 or FIG. 8-2.

For 2-step RACH, the MsgB PDU contains a subheader as shown by FIG. 8x-1, FIG. 8x-2, and/or FIG. 8x-3.

Field T indicates whether it backoff Indication (T=00), or it is one of the fallbackRAR (e.g., T=01 is for non-SDT and T=10 for SDT fallback). In some embodiments, the field T indicates whether it is a backoff indicator (or last MAC subPDU), FallbackRAR (SDT or non-SDT), and/or SuccessRAR.

If segmentation of the data/traffic to be exchanged via SDT (or EDT), the mechanisms described in this invention may also be used. Therefore, there might be cases when the Msg.3 payload generated by the UE would be included segmented data to fit in the allowed TBS for Msg.3 transmission (where padding could also be added when needed). Moreover, there could be cases where network controls whether segmentation is or not allowed when using SDT (or SDT) feature or given RACH configuration.

A MAC PDU for MsgB includes one or more MAC subPDUs and optionally padding. Each MAC subPDU consists one of the following:
a MAC subheader with Backoff Indicator only;
a MAC subheader and fallbackRAR;
a MAC subheader and successRAR;
a MAC subheader and MAC SDU for CCCH or DCCH;
a MAC subheader and padding.

A MAC subheader with Backoff Indicator includes five header fields E/T1/T2/R/BI as described in FIG. 8a-1. A MAC subPDU with Backoff Indicator only is placed at the beginning of the MAC PDU, if included.

A MAC subheader for fallbackRAR includes three header fields E/T1/RAPID as described in FIG. 8a-2. A MAC subheader for successRAR includes eight header fields E/T1/T2/S/R/R/R/R as described in FIG. 8a-3. A MAC subheader for MAC SDU includes the four header fields R/F/LCID/L as shown and described by FIG. 6.1.2-1 and FIG. 6.1.2-2 of TS 38.321.

At most one ‘MAC subPDU for success RAR’ indicating presence of ‘MAC subPDU(s) for MAC SDU’ is included in a MAC PDU. MAC subPDU(s) for MAC SDU are placed immediately after the ‘MAC subPDU for success RAR’ indicating presence of ‘MAC subPDU(s) for MAC SDU’.

If MAC PDU includes MAC subPDU(s) for MAC SDU, the last MAC subPDU for MAC SDU is placed before MAC subPDU with padding as depicted in FIG. 8a-4. Otherwise, the last MAC subPDU in MAC PDU is placed before padding as depicted in FIG. 8a-5. The MAC subPDU with padding includes R/R/LCID MAC subheader as shown by FIG. 6.1.2-3 of TS 38.321 and padding. The size of padding in the MAC subPDU with padding can be zero. The length of padding is implicit based on TB size, size of MAC subPDU(s).

### IV. RANDOM ACCESS PROCEDURE

Prior to initiation of a physical random access (PRACH) procedure, Layer 1 (L1) receives from higher layers a set of SS/PBCH block indexes and provides to higher layers a corresponding set of RSRP measurements. Prior to initiation of the PRACH procedure, L1 may receive from higher layers an indication to perform a Type-1 random access procedure (e.g., the 4-step PRACH procedure as shown by FIG. 1 and/or as described in Clauses 8.1 through 8.4 of TS 38.213, v. 16.1.0, 2020-04-03) or a Type-2 random access procedure as (e.g., as shown by FIG. 2 and/or as described in Clauses 8.1 through 8.2A of TS 38.213). Prior to initiation of the PRACH procedure, L1 receives the following information from the higher layers:
Configuration of physical random access channel (PRACH) transmission parameters (PRACH preamble format, time resources, and frequency resources for PRACH transmission).
Parameters for determining the root sequences and their cyclic shifts in the PRACH preamble sequence set (index to logical root sequence table, cyclic shift (N_{CS}), and set type (unrestricted, restricted set A, or restricted set B)).

From the physical layer (e.g., L1) perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer (e.g., L1) perspective, the Type-2 L1 random access procedure includes the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

If a random access procedure is initiated by a PDCCH order to the UE, a PRACH transmission is with a same SCS as a PRACH transmission initiated by higher layers.

If a UE is configured with two UL carriers for a serving cell and the UE detects a PDCCH order, the UE uses the UL/SUL indicator field value from the detected PDCCH order to determine the UL carrier for the corresponding PRACH transmission.

### IV.1. Random Access Preamble

Physical random access procedure is triggered upon request of a PRACH transmission by higher layers or by a PDCCH order. A configuration by higher layers for a PRACH transmission includes the following:
A configuration for PRACH transmission.
A preamble index, a preamble SCS, P_{PRACH, target}, a corresponding RA-RNTI, and a PRACH resource.
   A PRACH is transmitted using the selected PRACH format with transmission power P_{PRACH,b,f,c} (i), as described in Clause 7.4, on the indicated PRACH resource.

For Type-1 random access procedure, a UE is provided a number N of SS/PBCH block indexes associated with one PRACH occasion and a number R of contention based preambles per SS/PBCH block index per valid PRACH occasion by ssb-perRACH-OccasionAndCB-PreamblesPerSSB.

For Type-2 random access procedure with common configuration of PRACH occasions with Type-1 random access procedure, a UE is provided a number N of SS/PBCH block indexes associated with one PRACH occasion by ssb-perRACH-OccasionAndCB-PreamblesPerSSB and a number Q of contention based preambles per SS/PBCH block index per valid PRACH occasion by msgA-CB-PreamblesPerSSB. The PRACH transmission can be on a subset of PRACH occasions associated with a same SS/PBCH block index for a UE provided with a PRACH mask index by msgA-ssb-sharedRO-MaskIndex according to TS 38.321.

For Type-2 random access procedure with separate configuration of PRACH occasions with Type-1 random access procedure, a UE is provided a number N of SS/PBCH block indexes associated with one PRACH occasion and a number R of contention based preambles per SS/PBCH block index per valid PRACH occasion by ssb-perRACH-OccasionAndCB-PreamblesPerSSB-msgA when provided; otherwise, by ssb-perRACH-OccasionAndCB-PreamblesPerSSB.

For Type-1 random access procedure, or for Type-2 random access procedure with separate configuration of PRACH occasions from Type 1 random access procedure, if N<1, one SS/PBCH block index is mapped to 1/N consecutive valid PRACH occasions and R contention based preambles with consecutive indexes associated with the SS/PBCH block index per valid PRACH occasion start from preamble index 0. If N≥1, R contention based preambles with consecutive indexes associated with SS/PBCH block index n, 0≤n≤N−1, per valid PRACH occasion start from preamble index n·Nₚᵣₑₐₘₚₗₑ^{total}/N where N_{preamble}^{total} is provided by totalNumberOfRA-Preambles for Type-1 random access procedure, or by msgA-totalNumberOfRA-Preambles for Type-2 random access procedure with separate configuration of PRACH occasions from a Type 1 random access procedure, and is an integer multiple of N.

For Type-2 random access procedure with common configuration of PRACH occasions with Type-1 random access procedure, if N<1, one SS/PBCH block index is mapped to 1/N consecutive valid PRACH occasions and Q contention based preambles with consecutive indexes associated with the SS/PBCH block index per valid PRACH occasion start from preamble index R. If N≥1, Q contention based preambles with consecutive indexes associated with SS/PBCH block index n, 0≤n≤N−1, per valid PRACH occasion start from preamble index n·N_{preamble}^{total}/N+R, where N_{preamble}^{total} is provided by totalNumberOfRA-Preambles for Type-1 random access procedure.

For link recovery, a UE is provided N SS/PBCH block indexes associated with one PRACH occasion by ssb-perRACH-Occasion in BeamFailureRecoveryConfig. For a dedicated RACH configuration provided by RACH-ConfigDedicated, if cfra is provided, a UE is provided N SS/PBCH block indexes associated with one PRACH occasion by ssb-perRACH-Occasion in occasions. If N<1, one SS/PBCH block index is mapped to 1/N consecutive valid PRACH occasions. If N≥1, all consecutive N SS/PBCH block indexes are associated with one PRACH occasion.

SS/PBCH block indexes provided by ssb-PositionsInBurst in SIB1 or in ServingCellConfigCommon are mapped to valid PRACH occasions in the following order.
First, in increasing order of preamble indexes within a single PRACH occasion
Second, in increasing order of frequency resource indexes for frequency multiplexed PRACH occasions
Third, in increasing order of time resource indexes for time multiplexed PRACH occasions within a PRACH slot
Fourth, in increasing order of indexes for PRACH slots

An association period, starting from frame 0, for mapping SS/PBCH block indexes to PRACH occasions is the smallest value in the set determined by the PRACH configuration period according Table IV.1-1 such that N_{Tx}^{SSB} SS/PBCH block indexes are mapped at least once to the PRACH occasions within the association period, where a UE obtains N_{Tx}^{SSB} from the value of ssb-PositionsInBurst in SIB1 or in ServingCellConfigCommon. If after an integer number of SS/PBCH block indexes to PRACH occasions mapping cycles within the association period there is a set of PRACH occasions or PRACH preambles that are not mapped to N_{Tx}^{SSB} SS/PBCH block indexes, no SS/PBCH block indexes are mapped to the set of PRACH occasions or PRACH preambles. An association pattern period includes one or more association periods and is determined so that a pattern between PRACH occasions and SS/PBCH block indexes repeats at most every 160 msec. PRACH occasions not associated with SS/PBCH block indexes after an integer number of association periods, if any, are not used for PRACH transmissions.

For a PRACH transmission triggered by a PDCCH order, the PRACH mask index field, if the value of the random access preamble index field is not zero, indicates the PRACH occasion for the PRACH transmission where the PRACH occasions are associated with the SS/PBCH block index indicated by the SS/PBCH block index field of the PDCCH order.

For a PRACH transmission triggered by higher layers, if ssb-ResourceList is provided, the PRACH mask index is indicated by ra-ssb-OccasionMaskIndex which indicates the PRACH occasions for the PRACH transmission where the PRACH occasions are associated with the selected SS/PBCH block index.

The PRACH occasions are mapped consecutively per corresponding SS/PBCH block index. The indexing of the PRACH occasion indicated by the mask index value is reset per mapping cycle of consecutive PRACH occasions per SS/PBCH block index. The UE selects for a PRACH transmission the PRACH occasion indicated by PRACH mask index value for the indicated SS/PBCH block index in the first available mapping cycle.

For the indicated preamble index, the ordering of the PRACH occasions is
First, in increasing order of frequency resource indexes for frequency multiplexed PRACH occasions
Second, in increasing order of time resource indexes for time multiplexed PRACH occasions within a PRACH slot
Third, in increasing order of indexes for PRACH slots

For a PRACH transmission triggered upon request by higher layers, a value of ra-OccasionList, if csirs-ResourceList is provided, indicates a list of PRACH occasions for the PRACH transmission where the PRACH occasions are associated with the selected CSI-RS index indicated by csi-RS. The indexing of the PRACH occasions indicated by ra-OccasionList is reset per association pattern period.

TABLE IV.1-1
Mapping between PRACH configuration period and SS/PBCH
block to PRACH occasion association period

| PRACH configuration period | Association period (number of |
|---|---|
| (msec) | PRACH configuration periods) |
| 10 | {1, 2, 4, 8, 16} |
| 20 | {1, 2, 4, 8} |
| 40 | {1, 2, 4} |
| 80 | {1, 2} |
| 160 | {1} |

For paired spectrum all PRACH occasions are valid.

For unpaired spectrum,
if a UE is not provided tdd-UL-DL-ConfigurationCommon, a PRACH occasion in a PRACH slot is valid if it does not precede a SS/PBCH block in the PRACH slot and starts at least N_{gap} symbols after a last SS/PBCH block reception symbol, where N_{gap} is provided in Table IV.1-2 and, if ChannelAccessMode-r16=semistatic is provided, does not overlap with a set of consecutive symbols before the start of a next channel occupancy time where the UE does not transmit.
   the candidate SS/PBCH block index of the SS/PBCH block corresponds to the SS/PBCH block index provided by ssb-PositionsInBurst in SIB1 or in ServingCellConfigCommon, as described in Clause 4.1 in TS 38.213.
If a UE is provided tdd-UL-DL-ConfigurationCommon, a PRACH occasion in a PRACH slot is valid if
   it is within UL symbols, or
   it does not precede a SS/PBCH block in the PRACH slot and starts at least N_{gap} symbols after a last downlink symbol and at least N_{gap} symbols after a last SS/PBCH block symbol, where N_{gap} is provided in Table IV.1-2, and if ChannelAccessMode-r16=semistatic is provided, does not overlap with a set of consecutive symbols before the start of a next channel occupancy time where there shall not be any transmissions.
      the candidate SS/PBCH block index of the SS/PBCH block corresponds to the SS/PBCH block index provided by ssb-PositionsInBurst in SIB1 or in ServingCellConfigCommon, as described in Clause 4.1.

For preamble format B4, N_{gap}=0 N_{gap}=0.

TABLE IV.1-2
N_{gap} values for different preamble SCS μ

| Preamble SCS | N_{gap} |
|---|---|
| 1.25 kHz or 5 kHz | 0 |
| 15 kHz or 30 kHz or 60 kHz or | 2 |
| 120 kHz | |

If a random access procedure is initiated by a PDCCH order, the UE, if requested by higher layers, transmits a PRACH in the selected PRACH occasion, for which a time between the last symbol of the PDCCH order reception and the first symbol of the PRACH transmission is larger than or equal to N_{T,2}+Δ_{BWPSwitching}+Δ_{Delay}+T_{switch} msec, where
N_{T,2} is a time duration of N₂ symbols corresponding to a PUSCH preparation time for UE processing capability 1 assuming μ corresponds to the smallest SCS configuration between the SCS configuration of the PDCCH order and the SCS configuration of the corresponding PRACH transmission
Δ_{BWPSwitching}=0 if the active UL BWP does not change and Δ_{BWPSwitching} is defined in any suitable manner otherwise.
Δ_{Delay}=0.5 msec for FR1 and Δ_{Delay}=0.25 msec for FR2
T_{switch} is a switching gap duration

For a PRACH transmission using 1.25 kHz or 5 kHz SCS, the UE determines N₂ assuming SCS configuration μ=0.

For single cell operation or for operation with carrier aggregation in a same frequency band, a UE does not transmit PRACH and PUSCH/PUCCH/SRS in a same slot or when a gap between the first or last symbol of a PRACH transmission in a first slot is separated by less than N symbols from the last or first symbol, respectively, of a PUSCH/PUCCH/SRS transmission in a second slot where N=2 for μ=0 or μ=1, N=4 for μ=2 or μ=3, and μ is the SCS configuration for the active UL BWP. For a PUSCH transmission with repetition Type B, this applies to each actual repetition for PUSCH transmission.

IV.1A PUSCH for Type-2 Random Access Procedure

For a Type-2 random access procedure, a UE transmits a PUSCH, when applicable, after transmitting a PRACH. The UE encodes a transport block provided for the PUSCH transmission using redundancy version number 0. The PUSCH transmission is after the PRACH transmission by at least N symbols where N=2 for μ=0 or μ=1, N=4 for μ=2 or μ=3, and μ is the SCS configuration for the active UL BWP.

A UE does not transmit a PUSCH in a PUSCH occasion if the PUSCH occasion associated with a DMRS resource is not mapped to a preamble of valid PRACH occasions or if the associated PRACH preamble is not transmitted as described in Clause 7.5 or Clause 11.1. A UE can transmit a PRACH preamble in a valid PRACH occasion if the PRACH preamble is not mapped to a valid PUSCH occasion.

A mapping between one or multiple PRACH preambles and a PUSCH occasion associated with a DMRS resource is per PUSCH configuration.

A UE determines time resources and frequency resources for PUSCH occasions in an active UL BWP from msgA-PUSCH-Config for the active UL BWP. If the active UL BWP is not the initial UL BWP and msgA-PUSCH-Config is not provided for the active UL BWP, the UE uses the msgA-PUSCH-Config provided for the initial UL BWP.

A UE determines a first interlace or first RB for a first PUSCH occasion in an active UL BWP respectively from interlaceIndexFirstPO-MsgA-PUSCH or from frequencyStartMsgA-PUSCH that provides an offset, in number of RBs in the active UL BWP, from a first RB of the active UL BWP. A PUSCH occasion includes a number of interlaces or a number of RBs provided by nrofInterlacesPerMsgA-PO or by nrofPRBs-perMsgA-PO, respectively. Consecutive PUSCH occasions in the frequency domain of an UL BWP are separated by a number of RBs provided by guardBandMsgA-PUSCH. A number N_{f} of PUSCH occasions in the frequency domain of an UL BWP is provided by nrMsgA-PO-FDM.

If a UE does not have dedicated RRC configuration, or has an initial UL BWP as an active UL BWP, or is not provided startSymbolAndLengthMsgA-PO, msgA-PUSCH-timeDomainAllocation provides a SLIV and a PUSCH mapping type for a PUSCH transmission by indicating
first maxNrofUL-Allocations values from PUSCH-TimeDomainResourceAllocationList, if PUSCH-TimeDomainResourceAllocationList is provided in PUSCH-ConfigCommon
if PUSCH-TimeDomainResourceAllocationList is not provided in PUSCH-ConfigCommon

else, the is provided a SLIV by startSymbolAndLengthMsgA-PO, and a PUSCH mapping type by mappingTypeMsgA-PUSCH for a PUSCH transmission.

For mapping one or multiple preambles of a PRACH slot to a PUSCH occasion associated with a DMRS resource, a UE determines a first slot for a first PUSCH occasion in an active UL BWP from msgA-PUSCH-TimeDomainOffset that provides an offset, in number of slots in the active UL BWP, relative to the start of a PUSCH slot including the start of each PRACH slot. The UE does not expect to have a PRACH preamble transmission and a PUSCH transmission with a msgA in a PRACH slot or in a PUSCH slot, or to have overlapping msgA PUSCH occasions for a MsgA PUSCH configuration. The UE expects that a first PUSCH occasion in each slot has a same SLIV for a PUSCH transmission that is provided by startSymbolAndLengthMsgA-PO.

Consecutive PUSCH occasions within each slot are separated by guardPeriodMsgA-PUSCH symbols and have same duration. A number Nₜ of time domain PUSCH occasions in each slot is provided by nrofMsgA-PO-perSlot and a number Nₛ of consecutive slots that include PUSCH occasions is provided by nrofSlotsMsgA-PUSCH.

A UE is provided a DMRS configuration for a PUSCH transmission in a PUSCH occasion in an active UL BWP by msgA-DMRS-Configuration.

A UE is provided an MCS for data information in a PUSCH transmission for a PUSCH occasion by msgA-MCS.

For a PUSCH transmission with frequency hopping in a slot, when indicated by msgA-intraSlotFrequencyHopping for the active UL BWP, the frequency offset for the second hop is determined using msgA-HoppingBits instead of N_{UL,hop}. If guardPeriodMsgA-PUSCH is provided, a first symbol of the second hop is separated by guardPeriodMsgA-PUSCH symbols from the end of a last symbol of the first hop; otherwise, there is no time separation of the PUSCH transmission before and after frequency hopping. If a UE is provided with useInterlacePUCCH-PUSCH in BWP-UplinkCommon, the UE shall transmit PUSCH without frequency hopping. A PUSCH transmission uses a same spatial filter as an associated PRACH transmission.

A UE determines whether or not to apply transform precoding for a PUSCH transmission.

A PUSCH occasion for PUSCH transmission is defined by a frequency resource and a time resource, and is associated with a DMRS resource. The DMRS resources are provided by msgA-DMRS-Configuration.

Each consecutive number of N_{preamble} preamble indexes from valid PRACH occasions in a PRACH slot
first, in increasing order of preamble indexes within a single PRACH occasion
second, in increasing order of frequency resource indexes for frequency multiplexed PRACH occasions
third, in increasing order of time resource indexes for time multiplexed PRACH occasions within a PRACH slot
   are mapped to a valid PUSCH occasion and the associated DMRS resource
first, in increasing order of frequency resource indexes f_{id} for frequency multiplexed PUSCH occasions
second, in increasing order of DMRS resource indexes within a PUSCH occasion, where a DMRS resource index DMRS_{id} is determined first in an ascending order of a DMRS port index and second in an ascending order of a DMRS sequence index
third, in increasing order of time resource indexes t_{id} for time multiplexed PUSCH occasions within a PUSCH slot
fourth, in increasing order of indexes for Nₛ PUSCH slots

where N_{preamble}=ceil(T_{preamble}/T_{PUSCH}), T_{preamble} is a total number of valid PRACH occasions per association pattern period multiplied by the number of preambles per valid PRACH occasion provided by msgA-PUSCH-PreambleGroup, and T_{PUSCH} is a total number of valid PUSCH occasions per PUSCH configuration per association pattern period multiplied by the number of DMRS resource indexes per valid PUSCH occasion provided by msgA-DMRS-Configuration.

A PUSCH occasion is valid if it does not overlap in time and frequency with any PRACH occasion associated with either a Type-1 random access procedure or a Type-2 random access procedure. Additionally, for unpaired spectrum and for SS/PBCH blocks with indexes provided by ssb-PositionsInBurst in SIB1 or by ServingCellConfigCommon
if a UE is not provided tdd-UL-DL-ConfigurationCommon, a PUSCH occasion is valid if the PUSCH occasion
   does not precede a SS/PBCH block in the PUSCH slot, and
   starts at least N_{gap} symbols after a last SS/PBCH block symbol, where N_{gap} is provided in Table IV.1-2
if a UE is provided tdd-UL-DL-ConfigurationCommon, a PUSCH occasion is valid if the PUSCH occasion
   is within UL symbols, or
   does not precede a SS/PBCH block in the PUSCH slot, and
   starts at least N_{gap} symbols after a last downlink symbol and at least N_{gap} symbols after a last SS/PBCH block symbol, where N_{gap} is provided in Table IV.1-2 and, if ChannelAccessMode-r16=semistatic is provided, does not overlap with a set of consecutive symbols before the start of a next channel occupancy time where the UE does not transmit.

IV.2 Random Access Response—Type-1 Random Access Procedure

In response to a PRACH transmission, a UE attempts to detect a DCI format 1_0 with CRC scrambled by a corresponding RA-RNTI during a window controlled by higher layers. The window starts at the first symbol of the earliest CORESET the UE is configured to receive PDCCH for Type 1-PDCCH CSS set, as defined in Clause 10.1, that is at least one symbol, after the last symbol of the PRACH occasion corresponding to the PRACH transmission, where the symbol duration corresponds to the SCS for Type1-PDCCH CSS set as defined in Clause 10.1. The length of the window in number of slots, based on the SCS for Type1-PDCCH CSS set, is provided by ra-Response Window.

If the UE detects the DCI format 1_0 with CRC scrambled by the corresponding RA-RNTI and LSBs of a SFN field in the DCI format 1_0, if included and applicable, are same as corresponding LSBs of the SFN where the UE transmitted PRACH, and the UE receives a transport block in a corresponding PDSCH within the window, the UE passes the transport block to higher layers. The higher layers parse the transport block for a random access preamble identity (RAPID) associated with the PRACH transmission. If the higher layers identify the RAPID in RAR message(s) of the transport block, the higher layers indicate an uplink grant to the physical layer. This is referred to as random access response (RAR) UL grant in the physical layer.

If the UE does not detect the DCI format 1_0 with CRC scrambled by the corresponding RA-RNTI within the window, or if the UE detects the DCI format 1_0 with CRC scrambled by the corresponding RA-RNTI within the window and LSBs of a SFN field in the DCI format 1_0, if included and applicable, are not same as corresponding LSBs of the SFN where the UE transmitted PRACH, or if the UE does not correctly receive the transport block in the corresponding PDSCH within the window, or if the higher layers do not identify the RAPID associated with the PRACH transmission from the UE, the higher layers can indicate to the physical layer to transmit a PRACH. If requested by higher layers, the UE is expected to transmit a PRACH no later than N_{T,1}+0.75 msec after the last symbol of the window, or the last symbol of the PDSCH reception, where N_{T,1} is a time duration of N, symbols corresponding to a PDSCH processing time for UE processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH. For μ=0, the UE assumes N_{1,D}=14. For a PRACH transmission using 1.25 kHz or 5 kHz SCS, the UE determines N₁ assuming SCS configuration μ=0.

If the UE detects a DCI format 1_0 with CRC scrambled by the corresponding RA-RNTI and LSBs of a SFN field in the DCI format 1_0, if included and applicable, are same as corresponding LSBs of the SFN where the UE transmitted the PRACH, and the UE receives a transport block in a corresponding PDSCH, the UE may assume same DM-RS antenna port quasi co-location properties, as for a SS/PBCH block or a CSI-RS resource the UE used for PRACH association, as described in Clause IV.1, regardless of whether or not the UE is provided TCI-State for the CORESET where the UE receives the PDCCH with the DCI format 1_0.

If the UE attempts to detect the DCI format 1_0 with CRC scrambled by the corresponding RA-RNTI in response to a PRACH transmission initiated by a PDCCH order that triggers a contention-free random access procedure for the SpCell, the UE may assume that the PDCCH that includes the DCI format 1_0 and the PDCCH order have same DM-RS antenna port quasi co-location properties. If the UE attempts to detect the DCI format 1_0 with CRC scrambled by the corresponding RA-RNTI in response to a PRACH transmission initiated by a PDCCH order that triggers a contention-free random access procedure for a secondary cell, the UE may assume the DM-RS antenna port quasi co-location properties of the CORESET associated with the Type1-PDCCH CSS set for receiving the PDCCH that includes the DCI format 1_0.

A RAR UL grant schedules a PUSCH transmission from the UE. The contents of the RAR UL grant, starting with the MSB and ending with the LSB, are given in Table IV.2-1.

If the value of the frequency hopping flag is 0, the UE transmits the PUSCH without frequency hopping; otherwise, the UE transmits the PUSCH with frequency hopping.

The UE determines the MCS of the PUSCH transmission from the first sixteen indexes of the applicable MCS index table for PUSCH.

The TPC command value δ_{msg2,b,f,c} is used for setting the power of the PUSCH transmission, as described in Clause 7.1.1 of TS 38.213, and is interpreted according to Table IV.2-2 infra and/or table II-1 shown supra.

The CSI request field is reserved.

The ChannelAccess-CPext field indicates a channel access type and CP extension for operation with shared spectrum channel access.

TABLE IV.2-1
Random Access Response Grant Content field size

| RAR grant field | Number of bits |
|---|---|
| Frequency hopping flag | 1 |
| PUSCH frequency resource | 14, for operation without shared |
| allocation | spectrum channel access |
| | 12, for operation with shared |
| | spectrum channel access |
| PUSCH time resource allocation | 4 |
| MCS | 4 |
| TPC command for PUSCH | 3 |
| CSI request | 1 |
| ChannelAccess-CPext | 0, for operation without shared |
| | spectrum channel access |
| | 2, for operation with shared |
| | spectrum channel access |

TABLE IV.2-2
TPC Command δ_{msg 2, b, f, c} for PUSCH

| TPC Command | Value (in dB) |
|---|---|
| 0 | −6 |
| 1 | −4 |
| 2 | −2 |
| 3 | 0 |
| 4 | 2 |
| 5 | 4 |
| 6 | 6 |
| 7 | 8 |

Unless the UE is configured a SCS, the UE receives subsequent PDSCH using same SCS as for the PDSCH reception providing the RAR message.

If the UE does not detect the DCI format 1_0 with CRC scrambled by the corresponding RA-RNTI within the window, or if the UE detects the DCI format 1_0 with CRC scrambled by the corresponding RA-RNTI within the window and the LSBs of a SFN field in the DCI format 1_0, if included and applicable, are not same as corresponding LSBs of the SFN where the UE transmitted the PRACH, or the UE does not correctly receive a corresponding transport block within the window, the UE procedure is as described in TS 38.321.

IV.2A Random Access Response—Type-2 Random Access Procedure

In response to a transmission of a PRACH and a PUSCH, or to a transmission of only a PRACH if the PRACH preamble is mapped to a valid PUSCH occasion, a UE attempts to detect a DCI format 1_0 with CRC scrambled by a corresponding MsgB-RNTI during a window controlled by higher layers. The window starts at the first symbol of the earliest CORESET the UE is configured to receive PDCCH for Type1-PDCCH CSS set, as defined in Clause 10.1, that is at least one symbol, after the last symbol of the PUSCH occasion corresponding to the PRACH transmission, where the symbol duration corresponds to the SCS for Type1-PDCCH CSS set. The length of the window in number of slots, based on the SCS for Type1-PDCCH CSS set, is provided by msgB-ResponseWindow.

In response to a transmission of a PRACH, if the PRACH preamble is not mapped to a valid PUSCH occasion, a UE attempts to detect a DCI format 1_0 with CRC scrambled by a corresponding MsgB-RNTI during a window controlled by higher layers. The window starts at the first symbol of the earliest CORESET the UE is configured to receive PDCCH for Type 1-PDCCH CSS set, as defined in Clause 10.1, that is at least one symbol, after the last symbol of the PRACH occasion corresponding to the PRACH transmission, where the symbol duration corresponds to the SCS for Type1-PDCCH CSS set. The length of the window in number of slots, based on the SCS for Type1-PDCCH CSS set, is provided by msgB-ResponseWindow.

If the UE detects the DCI format 1_0, with CRC scrambled by the corresponding MsgB-RNTI and LSBs of a SFN field in the DCI format 1_0, if applicable, are same as corresponding LSBs of the SFN where the UE transmitted PRACH, and the UE receives a transport block in a corresponding PDSCH within the window, the UE passes the transport block to higher layers. The higher layers indicate to the physical layer
an uplink grant if the RAR message(s) is for fallbackRAR and a random access preamble identity (RAPID) associated with the PRACH transmission is identified, and the UE procedure continues as described in Clauses IV.2, IV.3, and IV.4 when the UE detects a RAR UL grant, or
transmission of a PUCCH with HARQ-ACK information having ACK value if the RAR message(s) is for successRAR, where
   a PUCCH resource for the transmission of the PUCCH is indicated by PUCCH resource indicator field of 4 bits in the successRAR from a PUCCH resource set that is provided by pucch-ResourceCommon
   a slot for the PUCCH transmission is indicated by a PDSCH-to-HARQ feedback timing indicator field of 3 bits in the successRAR having a value k from {1, 2, 3, 4, 5, 6, 7, 8} and, with reference to slots for PUCCH transmission having duration Tₛₗₒₜ, the slot is determined as n+k+Δ, where n is a slot of the PDSCH reception and Δ is as defined for PUSCH transmission
      the UE does not expect the first symbol of the PUCCH transmission to be after the last symbol of the PDSCH reception by a time smaller than N_{T,1}+0.5 msec where N_{T,1} is the PDSCH processing time for UE processing capability 1
   for operation with shared spectrum channel access, a channel access type and CP extension for a PUCCH transmission is indicated by a ChannelAccess-CPext field in the successRAR
   the PUCCH transmission is with a same spatial domain transmission filter and in a same active UL BWP as a last PUSCH transmission

If the UE detects the DCI format 1_0 with CRC scrambled by a C-RNTI and a transport block in a corresponding PDSCH within the window, the UE transmits a PUCCH with HARQ-ACK information having ACK value if the UE correctly detects the transport block or NACK value if the UE incorrectly detects the transport block and the time alignment timer is running.

If the UE detects a DCI format 1_0 with CRC scrambled by the corresponding MsgB-RNTI and receives a transport block within the window in a corresponding PDSCH, the UE may assume same DM-RS antenna port quasi co-location properties, as for a SS/PBCH block the UE used for PRACH association, as described in Clause IV.1, regardless of whether or not the UE is provided TCI-State for the CORESET where the UE receives the PDCCH with the DCI format 1_0.

The UE does not expect to be indicated to transmit the PUCCH with the HARQ-ACK information at a time that is prior to a time when the UE applies a TA command that is provided by the transport block. If the UE does not detect the DCI format 1_0 with CRC scrambled by the corresponding MsgB-RNTI within the window, or if the UE detects the DCI format 1_0 with CRC scrambled by the corresponding MsgB-RNTI within the window and LSBs of a SFN field in the DCI format 1_0, if applicable, are not same as corresponding LSBs of the SFN where the UE transmitted the PRACH, or if the UE does not correctly receive the transport block in the corresponding PDSCH within the window, or if the higher layers do not identify the RAPID associated with the PRACH transmission from the UE, the higher layers can indicate to the physical layer to transmit only PRACH according to Type-1 random access procedure or to transmit both PRACH and PUSCH according to Type-2 random access procedure. If requested by higher layers, the UE is expected to transmit a PRACH no later than N_{T,1}+0.75 msec after the last symbol of the window, or the last symbol of the PDSCH reception, where N_{T,1} is a time duration of N₁ symbols corresponding to a PDSCH processing time for UE processing capability 1 when additional PDSCH DM-RS is configured. For μ=0, the UE assumes N_{1,0}=14.

Unless the UE is configured a SCS, the UE receives subsequent PDSCH using same SCS as for the PDSCH reception providing the RAR message.

If the UE does not detect the DCI format 1_0 with CRC scrambled by the corresponding MsgB-RNTI within the window, or if the UE detects the 1_0 with CRC scrambled by the corresponding MsgB-RNTI within the window and LSBs of a SFN field in the DCI format 1_0, if applicable, are not same as corresponding LSBs of the SFN where the UE transmitted the PRACH, or the UE does not correctly receive a corresponding transport block within the window, the UE procedure is as described in TS 38.321.

IV.3 PUSCH Scheduled by RAR UL Grant

An active UL BWP, for a PUSCH transmission scheduled by a RAR UL grant is indicated by higher layers.

If useInterlace-PUCCH-PUSCH is not provided by BWP-UplinkCommon and BWP-UplinkDedicated, for determining the frequency domain resource allocation for the PUSCH transmission within the active UL BWP
if the active UL BWP and the initial UL BWP have same SCS and same CP length and the active UL BWP includes all RBs of the initial UL BWP, or the active UL BWP is the initial UL BWP, the initial UL BWP is used
else, the RB numbering starts from the first RB of the active UL BWP and the maximum number of RBs for frequency domain resource allocation equals the number of RBs in the initial UL BWP

The frequency domain resource allocation is by uplink resource allocation type 1. For an initial UL BWP size of N_{BWP}^{size} RBs, a UE processes the frequency domain resource assignment field as follows
if N_{BWP}^{size}≤180, or for operation with shared spectrum channel access if N_{BWP}^{size}≤90
   truncate the frequency domain resource assignment field to its [symbol] log₂(N_{BWP}^{size}·(N_{BWP}^{size}+1)/2) [symbol] least significant bits and interpret the truncated frequency resource assignment field as for the frequency resource assignment field in DCI format 0_0
else
   insert [symbol] log₂(N_{BWP}^{size}·(N_{BWP}^{size}+1)/2) [symbol] most significant bits, or for operation with shared spectrum channel access insert [symbol] log₂(N_{BWP}^{size}·(N_{BWP}^{size}+1)/2) [symbol] −12 most significant bits, with value set to ‘0’ after the N_{UL,hop} bits to the frequency domain resource assignment field, where N_{UL,hop}=0 if the frequency hopping flag is set to ‘0’ and N_{UL,hop} is provided in Table IV.3-1 if the hopping flag bit is set to ‘1’, and interpret the expanded frequency resource assignment field as for the frequency resource assignment field in DCI format 0_0
end if

If useInterlace-PUCCH-PUSCH is provided by BWP-UplinkCommon or BWP-UplinkDedicated, the frequency domain resource allocation is by uplink resource allocation type 2. A UE processes the frequency domain resource assignment field as follows
truncate the frequency domain resource assignment field to the X=6 LSBs if μ=0, or to the X=5 LSBs if μ=1
for interlace allocation of a PUSCH transmission, interpret the X MSBs of the truncated frequency domain resource assignment field for the active UL BWP as for the X MSBs of the frequency domain resource assignment field in DCI format 0_0
for RB set allocation of a PUSCH transmission, the RB set of the active UL BWP is the RB set of the PRACH transmission associated with the RAR UL grant
   A UE determines whether or not to apply transform precoding as described in.

For a PUSCH transmission with frequency hopping scheduled by RAR UL grant or for a Msg3 PUSCH retransmission, the frequency offset for the second hop is given in Table IV.3-1.

TABLE IV.3-1
Frequency offset for second hop of PUSCH transmission
with frequency hopping scheduled by RAR UL grant
or of Msg3 PUSCH retransmission

| Number of PRBs in | Value of N_{UL, hop} | Frequency offset for |
|---|---|---|
| initial UL BWP | Hopping Bits | 2^{nd} hop |
| N_{BWP}^{size} < 50 | 0 | [symbol] N_{BWP}^{size}/2 [symbol] |
| | 1 | [symbol] N_{BWP}^{size}/4 [symbol] |
| N_{BWP}^{size} ≥ 50 | 00 | [symbol] N_{BWP}^{size}/2 [symbol] |
| | 01 | [symbol] N_{BWP}^{size}/4 [symbol] |
| | 10 | − [symbol] N_{BWP}^{size}/4 [symbol] |
| | 11 | Reserved |

A SCS for the PUSCH transmission is provided by subcarrierSpacing in BWP-UplinkCommon. A UE transmits PRACH and the PUSCH on a same uplink carrier of a same serving cell.

A UE transmits a transport block in a PUSCH scheduled by a RAR UL grant in a corresponding RAR message using redundancy version number 0. If a TC-RNTI is provided by higher layers, the scrambling initialization of the PUSCH corresponding to the RAR UL grant in clause IV.2 is by TC-RNTI. Otherwise, the scrambling initialization of the PUSCH corresponding to the RAR UL grant in clause IV.2 is by C-RNTI. Msg3 PUSCH retransmissions, if any, of the transport block, are scheduled by a DCI format 0_0 with CRC scrambled by a TC-RNTI provided in the corresponding RAR message. The UE always transmits the PUSCH scheduled by a RAR UL grant without repetitions.

With reference to slots for a PUSCH transmission scheduled by a RAR UL grant, if a UE receives a PDSCH with a RAR message ending in slot n for a corresponding PRACH transmission from the UE, the UE transmits the PUSCH in slot n+k₂+Δ.

The UE may assume a minimum time between the last symbol of a PDSCH reception conveying a RAR message with a RAR UL grant and the first symbol of a corresponding PUSCH transmission scheduled by the RAR UL grant is equal to N_{T,1}+N_{T,2}+0.5 msec, where N_{T,1} is a time duration of N₁ symbols corresponding to a PDSCH processing time for UE processing capability 1 when additional PDSCH DM-RS is configured, N_{T,2} is a time duration of N₂ symbols corresponding to a PUSCH preparation time for UE processing capability 1 and, for determining the minimum time, the UE considers that N₁ and N₂ correspond to the smaller of the SCS configurations for the PDSCH and the PUSCH. For μ=0, the UE assumes N_{1,0}=14.

IV.4 PDSCH with UE Contention Resolution Identity

In response to a PUSCH transmission scheduled by a RAR UL grant when a UE has not been provided a C-RNTI, the UE attempts to detect a DCI format 1_0 with CRC scrambled by a corresponding TC-RNTI scheduling a PDSCH that includes a UE contention resolution identity. In response to the PDSCH reception with the UE contention resolution identity, the UE transmits HARQ-ACK information in a PUCCH. The PUCCH transmission is within a same active UL BWP as the PUSCH transmission. A minimum time between the last symbol of the PDSCH reception and the first symbol of the corresponding PUCCH transmission with the HARQ-ACK information is equal to N_{T,1}+0.5 msec. N_{T1,} is a time duration of N₁ symbols corresponding to a PDSCH processing time for UE processing capability 1 when additional PDSCH DM-RS is configured. For μ=0, the UE assumes N_{1,0}=14.

When detecting a DCI format in response to a PUSCH transmission scheduled by a RAR UL grant or corresponding PUSCH retransmission scheduled by a DCI format 0_0 with CRC scrambled by a TC-RNTI provided in the corresponding RAR message, the UE may assume the PDCCH carrying the DCI format has the same DM-RS antenna port quasi co-location properties as for a SS/PBCH block the UE used for PRACH association, as described in Clause IV.1, regardless of whether or not the UE is provided TCI-State for the CORESET where the UE receives the PDCCH with the DCI format.

### V. SYSTEMS AND IMPLEMENTATIONS

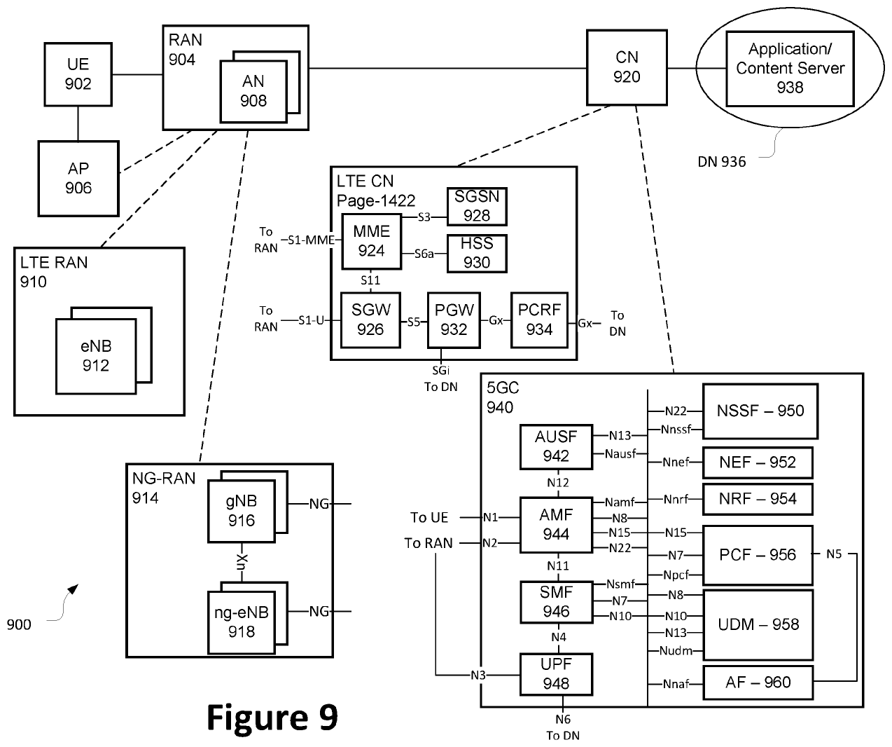

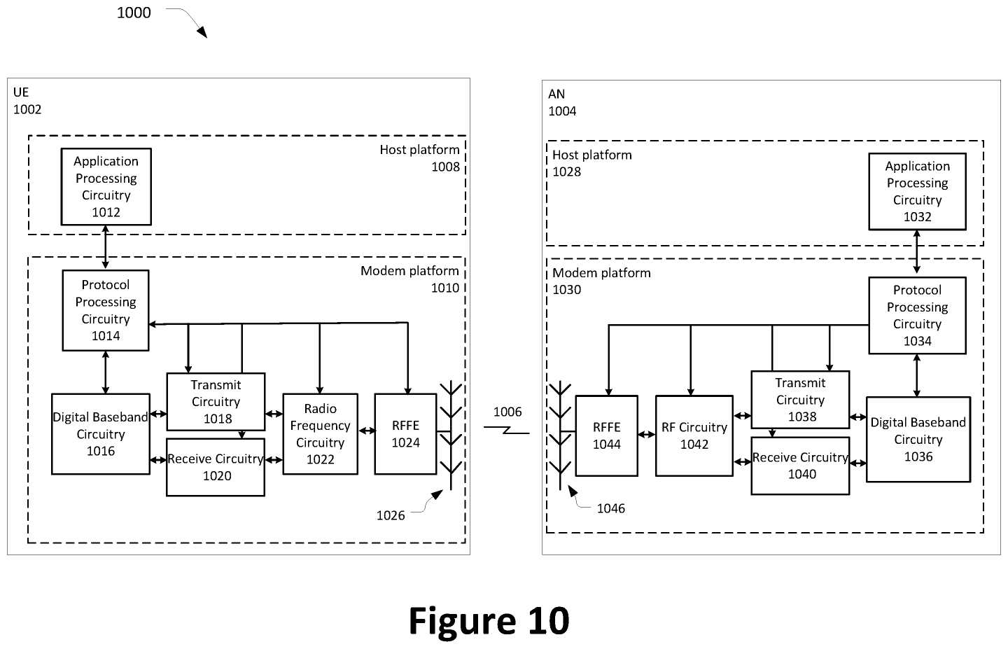

FIGS. 9-10 illustrate various systems, devices, and components that may implement aspects of disclosed embodiments.

FIG. 9 illustrates a network 900 in accordance with various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 includes a UE 902, which is any mobile or non-mobile computing device designed to communicate with a RAN 904 via an over-the-air connection. The UE 902 is communicatively coupled with the RAN 904 by a Uu interface, which may be applicable to both LTE and NR systems. Examples of the UE 902 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, and/or the like. The network 900 may include a plurality of UEs 902 coupled directly with one another via a D2D, ProSe, PC5, and/or sidelink interface. These UEs 902 may be M2M/D2D/MTC/IoT devices and/or vehicular systems that communicate using physical sidelink channels such as, but not limited to, PSBCH, PSDCH, PSSCH, PSCCH, PSFCH, etc. The UE 902 may be the same or similar as the UEs discussed previously with respect to any of the Figures discussed previously or infra.

In some embodiments, the UE 902 may additionally communicate with an AP 906 via an over-the-air (OTA) connection. The AP 906 manages a WLAN connection, which may serve to offload some/all network traffic from the RAN 904. The connection between the UE 902 and the AP 906 may be consistent with any IEEE 802.11 protocol. Additionally, the UE 902, RAN 904, and AP 906 may utilize cellular-WLAN aggregation/integration (e.g., LWA/LWIP). Cellular-WLAN aggregation may involve the UE 902 being configured by the RAN 904 to utilize both cellular radio resources and WLAN resources.

The RAN 904 includes one or more access network nodes (ANs) 908. The ANs 908 terminate air-interface(s) for the UE 902 by providing access stratum protocols including RRC, PDCP, RLC, MAC, and PHY/L1 protocols. In this manner, the AN 908 enables data/voice connectivity between CN 920 and the UE 902. The ANs 908 may be a macrocell base station or a low power base station for providing femtocells, picocells or other like cells having smaller coverage areas, smaller user capacity, or higher bandwidth compared to macrocells; or some combination thereof. In these implementations, an AN 908 be referred to as a BS, gNB, RAN node, eNB, ng-eNB, NodeB, RSU, TRxP, etc.

One example implementation is a “CU/DU split” architecture where the ANs 908 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like) (see e.g., 3GPP TS 38.401 v16.1.0 (2020-03)). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 908 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The plurality of ANs may be coupled with one another via an X2 interface (if the RAN 904 is an LTE RAN or Evolved Universal Terrestrial Radio Access Network (E-UTRAN) 910) or an Xn interface (if the RAN 904 is a NG-RAN 914). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs 908 of the RAN 904. For example, the UE 902 and RAN 904 may use carrier aggregation to allow the UE 902 to connect with a plurality of component carriers, each corresponding to a Pcell or Scell. In dual connectivity scenarios, a first AN 908 may be a master node that provides an MCG and a second AN 908 may be secondary node that provides an SCG. The first/second ANs 908 may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an E-UTRAN 910 with one or more eNBs 912. The an E-UTRAN 910 provides an LTE air interface (Uu) with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 904 may be an next generation (NG)-RAN 914 with one or more gNB 916 and/or on or more ng-eNB 918. The gNB 916 connects with 5G-enabled UEs 902 using a 5G NR interface. The gNB 916 connects with a 5GC 940 through an NG interface, which includes an N2 interface or an N3 interface. The ng-eNB 918 also connects with the 5GC 940 through an NG interface, but may connect with a UE 902 via the Uu interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN 914 and an AMF 944 (e.g., N2 interface).

The NG-RAN 914 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (e.g., PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements and/or network functions (NFs) to provide various functions to support data and telecommunications services to customers/subscribers (e.g., UE 902). The components of the CN 920 may be implemented in one physical node or separate physical nodes. In some embodiments, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

The CN 920 may be an LTE CN 922 (also referred to as an Evolved Packet Core (EPC) 922). The EPC 922 may include MME 924, SGW 926, SGSN 928, HSS 930, PGW 932, and PCRF 934 coupled with one another over interfaces (or “reference points”) as shown. The NFs in the EPC 922 are briefly introduced as follows.

The MME 924 implements mobility management functions to track a current location of the UE 902 to facilitate paging, bearer activation/deactivation, handovers, gateway selection, authentication, etc.

The SGW 926 terminates an S1 interface toward the RAN 910 and routes data packets between the RAN 910 and the EPC 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 tracks a location of the UE 902 and performs security functions and access control. The SGSN 928 also performs inter-EPC node signaling for mobility between different RAT networks; PDN and S-GW selection as specified by MME 924; MME 924 selection for handovers; etc. The S3 reference point between the MME 924 and the SGSN 928 enable user and bearer information exchange for inter-3GPP access network mobility in idle/active states.

The HSS 930 includes a database for network users, including subscription-related information to support the network entities' handling of communication sessions. The HSS 930 can provide support for routing/roaming, authentication, authorization, naming/addressing resolution, location dependencies, etc. An S6a reference point between the HSS 930 and the MME 924 may enable transfer of subscription and authentication data for authenticating/authorizing user access to the EPC 920.

The PGW 932 may terminate an SGi interface toward a data network (DN) 936 that may include an application (app)/content server 938. The PGW 932 routes data packets between the EPC 922 and the data network 936. The PGW 932 is communicatively coupled with the SGW 926 by an S5 reference point to facilitate user plane tunneling and tunnel management. The PGW 932 may further include a node for policy enforcement and charging data collection (e.g., PCEF). Additionally, the SGi reference point may communicatively couple the PGW 932 with the same or different data network 936. The PGW 932 may be communicatively coupled with a PCRF 934 via a Gx reference point.

The PCRF 934 is the policy and charging control element of the EPC 922. The PCRF 934 is communicatively coupled to the app/content server 938 to determine appropriate QoS and charging parameters for service flows. The PCRF 932 also provisions associated rules into a PCEF (via Gx reference point) with appropriate TFT and QCI.

The CN 920 may be a 5GC 940 including an AUSF 942, AMF 944, SMF 946, UPF 948, NSSF 950, NEF 952, NRF 954, PCF 956, UDM 958, and AF 960 coupled with one another over various interfaces as shown. The NFs in the 5GC 940 are briefly introduced as follows.

The AUSF 942 stores data for authentication of UE 902 and handle authentication-related functionality. The AUSF 942 may facilitate a common authentication framework for various access types.

The AMF 944 allows other functions of the 5GC 940 to communicate with the UE 902 and the RAN 904 and to subscribe to notifications about mobility events with respect to the UE 902. The AMF 944 is also responsible for registration management (e.g., for registering UE 902), connection management, reachability management, mobility management, lawful interception of AMF-related events, and access authentication and authorization. The AMF 944 provides transport for SM messages between the UE 902 and the SMF 946, and acts as a transparent proxy for routing SM messages. AMF 944 also provides transport for SMS messages between UE 902 and an SMSF. AMF 944 interacts with the AUSF 942 and the UE 902 to perform various security anchor and context management functions. Furthermore, AMF 944 is a termination point of a RAN-CP interface, which includes the N2 reference point between the RAN 904 and the AMF 944. The AMF 944 is also a termination point of NAS (N1) signaling, and performs NAS ciphering and integrity protection.

AMF 944 also supports NAS signaling with the UE 902 over an N3IWF interface. The N3IWF provides access to untrusted entities. N3IWF may be a termination point for the N2 interface between the (R)AN 904 and the AMF 944 for the control plane, and may be a termination point for the N3 reference point between the (R)AN 914 and the 948 for the user plane. As such, the AMF 944 handles N2 signalling from the SMF 946 and the AMF 944 for PDU sessions and QoS, encapsulate/de-encapsulate packets for IPSec and N3 tunnelling, marks N3 user-plane packets in the uplink, and enforces QoS corresponding to N3 packet marking taking into account QoS requirements associated with such marking received over N2. N3IWF may also relay UL and DL control-plane NAS signalling between the UE 902 and AMF 944 via an N1 reference point between the UE 902 and the AMF 944, and relay uplink and downlink user-plane packets between the UE 902 and UPF 948. The N3IWF also provides mechanisms for IPsec tunnel establishment with the UE 902. The AMF 944 may exhibit an Namf service-based interface, and may be a termination point for an N14 reference point between two AMFs 944 and an N17 reference point between the AMF 944 and a 5G-EIR (not shown by FIG. 9).

The SMF 946 is responsible for SM (e.g., session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM refers to management of a PDU session, and a PDU session or “session” refers to a PDU connectivity service that provides or enables the exchange of PDUs between the UE 902 and the DN 936.

The UPF 948 acts as an anchor point for intra-RAT and inter-RAT mobility, an external PDU session point of interconnect to data network 936, and a branching point to support multi-homed PDU session. The UPF 948 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 948 may include an uplink classifier to support routing traffic flows to a data network.

The NSSF 950 selects a set of network slice instances serving the UE 902. The NSSF 950 also determines allowed NSSAI and the mapping to the subscribed S-NSSAIs, if needed. The NSSF 950 also determines an AMF set to be used to serve the UE 902, or a list of candidate AMFs 944 based on a suitable configuration and possibly by querying the NRF 954. The selection of a set of network slice instances for the UE 902 may be triggered by the AMF 944 with which the UE 902 is registered by interacting with the NSSF 950; this may lead to a change of AMF 944. The NSSF 950 interacts with the AMF 944 via an N22 reference point; and may communicate with another NSSF in a visited network via an N31 reference point (not shown).

The NEF 952 securely exposes services and capabilities provided by 3GPP NFs for third party, internal exposure/re-exposure, AFs 960, edge computing or fog computing systems (e.g., edge compute node 936x, etc. In such embodiments, the NEF 952 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs, or used for other purposes such as analytics.

The NRF 954 supports service discovery functions, receives NF discovery requests from NF instances, and provides information of the discovered NF instances to the requesting NF instances. NRF 954 also maintains information of available NF instances and their supported services. The NRF 954 also supports service discovery functions, wherein the NRF 954 receives NF Discovery Request from NF instance or an SCP (not shown), and provides information of the discovered NF instances to the NF instance or SCP.

The PCF 956 provides policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 handles subscription-related information to support the network entities' handling of communication sessions, and stores subscription data of UE 902. For example, subscription data may be communicated via an N8 reference point between the UDM 958 and the AMF 944. The UDM 958 may include two parts, an application front end and a UDR. The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR 221 to allow the UDM 958, PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

AF 960 provides application influence on traffic routing, provide access to NEF 952, and interact with the policy framework for policy control. The AF 960 may influence UPF 948 (re)selection and traffic routing. Based on operator deployment, when AF 960 is considered to be a trusted entity, the network operator may permit AF 960 to interact directly with relevant NFs. Additionally, the AF 960 may be used for edge computing implementations,

The 5GC 940 may enable edge computing by selecting operator/3rd party services to be geographically close to a point that the UE 902 is attached to the network. This may reduce latency and load on the network. In edge computing implementations, the 5GC 940 may select a UPF 948 close to the UE 902 and execute traffic steering from the UPF 948 to DN 936 via the N6 interface. This may be based on the UE subscription data, UE location, and information provided by the AF 960, which allows the AF 960 to influence UPF (re)selection and traffic routing.

The data network (DN) 936 may represent various network operator services, Internet access, or third party services that may be provided by one or more servers including, for example, application (app)/content server 938. The DN 936 may be an operator external public, a private PDN, or an intra-operator packet data network, for example, for provision of IMS services. In this embodiment, the server 938 can be coupled to an IMS via an S-CSCF or the I-CSCF. In some implementations, the DN 936 may represent one or more local area DNs (LADNs), which are DNs 936 (or DN names (DNNs)) that is/are accessible by a UE 902 in one or more specific areas. Outside of these specific areas, the UE 902 is not able to access the LADN/DN 936.

Additionally or alternatively, the DN 936 may be an Edge DN 936, which is a (local) Data Network that supports the architecture for enabling edge applications. In these embodiments, the app server 938 may represent the physical hardware systems/devices providing app server functionality and/or the application software resident in the cloud or at an edge compute node that performs server function(s). In some embodiments, the app/content server 938 provides an edge hosting environment that provides support required for Edge Application Server's execution.

In some embodiments, the 5GS can use one or more edge compute nodes to provide an interface and offload processing of wireless communication traffic. In these embodiments, the edge compute nodes may be included in, or co-located with one or more RAN910, 914. For example, the edge compute nodes can provide a connection between the RAN 914 and UPF 948 in the 5GC 940. The edge compute nodes can use one or more NFV instances instantiated on virtualization infrastructure within the edge compute nodes to process wireless connections to and from the RAN 914 and UPF 948.

The interfaces of the 5GC 940 include reference points and service-based itnterfaces. The reference points include: N1 (between the UE 902 and the AMF 944), N2 (between RAN 914 and AMF 944), N3 (between RAN 914 and UPF 948), N4 (between the SMF 946 and UPF 948), N5 (between PCF 956 and AF 960), N6 (between UPF 948 and DN 936), N7 (between SMF 946 and PCF 956), N8 (between UDM 958 and AMF 944), N9 (between two UPFs 948), N10 (between the UDM 958 and the SMF 946), N11 (between the AMF 944 and the SMF 946), N12 (between AUSF 942 and AMF 944), N13 (between AUSF 942 and UDM 958), N14 (between two AMFs 944; not shown), N15 (between PCF 956 and AMF 944 in case of a non-roaming scenario, or between the PCF 956 in a visited network and AMF 944 in case of a roaming scenario), N16 (between two SMFs 946; not shown), and N22 (between AMF 944 and NSSF 950). Other reference point representations not shown in FIG. 9 can also be used. The service-based representation of FIG. 9 represents NFs within the control plane that enable other authorized NFs to access their services. The service-based interfaces (SBIs) include: Namf (SBI exhibited by AMF 944), Nsmf (SBI exhibited by SMF 946), Nnef (SBI exhibited by NEF 952), Npcf (SBI exhibited by PCF 956), Nudm (SBI exhibited by the UDM 958), Naf (SBI exhibited by AF 960), Nnrf (SBI exhibited by NRF 954), Nnssf (SBI exhibited by NSSF 950), Nausf (SBI exhibited by AUSF 942). Other service-based interfaces (e.g., Nudr, N5g-eir, and Nudsf) not shown in FIG. 9 can also be used. In some embodiments, the NEF 952 can provide an interface to edge compute nodes 936x, which can be used to process wireless connections with the RAN 914.

As discussed previously, the system 900 may include an SMSF, which is responsible for SMS subscription checking and verification, and relaying SM messages to/from the UE 902 to/from other entities, such as an SMS-GMSC/IWMSC/SMS-router. The SMS may also interact with AMF 942 and UDM 958 for a notification procedure that the UE 902 is available for SMS transfer (e.g., set a UE not reachable flag, and notifying UDM 958 when UE 902 is available for SMS).

The 5GS may also include an SCP (or individual instances of the SCP) that supports indirect communication (see e.g., 3GPP TS 23.501 section 7.1.1); delegated discovery (see e.g., 3GPP TS 23.501 section 7.1.1); message forwarding and routing to destination NF/NF service(s), communication security (e.g., authorization of the NF Service Consumer to access the NF Service Producer API) (see e.g., 3GPP TS 33.501), load balancing, monitoring, overload control, etc.; and discovery and selection functionality for UDM(s), AUSF(s), UDR(s), PCF(s) with access to subscription data stored in the UDR based on UE's SUPI, SUCI or GPSI (see e.g., 3GPP TS 23.501 section 6.3). Load balancing, monitoring, overload control functionality provided by the SCP may be implementation specific. The SCP may be deployed in a distributed manner. More than one SCP can be present in the communication path between various NF Services. The SCP, although not an NF instance, can also be deployed distributed, redundant, and scalable.

FIG. 10 schematically illustrates a wireless network 1000 in accordance with various embodiments. The wireless network 1000 includes a UE 1002 in wireless communication with an AN 1004. The UE 1002 and AN 104 may be the same, similar to, and/or substantially interchangeable with, like-named components described elsewhere herein such as the UE 902 and RAN 904 of FIG. 9.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHz frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

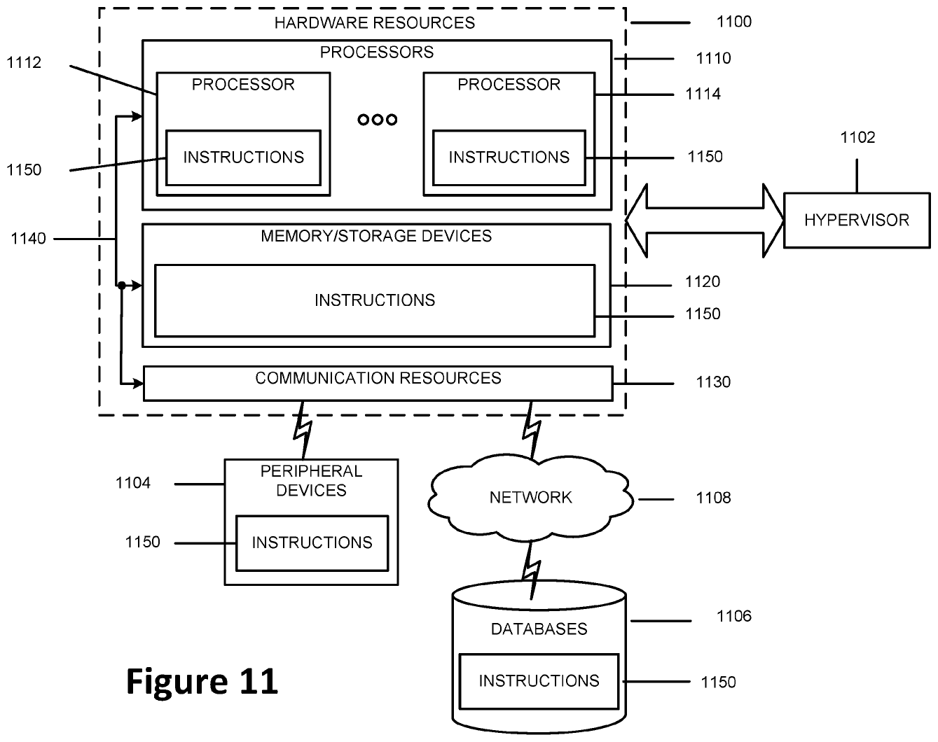

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1100.

The processors 1110 include, for example, processor 1112 and processor 1114. The processors 1110 include circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. The processors 1110 may be, for example, a central processing unit (CPU), reduced instruction set computing (RISC) processors, Acorn RISC Machine (ARM) processors, complex instruction set computing (CISC) processors, graphics processing units (GPUs), one or more Digital Signal Processors (DSPs) such as a baseband processor, Application-Specific Integrated Circuits (ASICs), an Field-Programmable Gate Array (FPGA), a radio-frequency integrated circuit (RFIC), one or more microprocessors or controllers, another processor (including those discussed herein), or any suitable combination thereof. In some implementations, the processor circuitry 1110 may include one or more hardware accelerators, which may be microprocessors, programmable processing devices (e.g., FPGA, complex programmable logic devices (CPLDs), etc.), or the like.

The memory/storage devices 1120 may include main memory, disk storage, or any suitable combination thereof. The memory/storage devices 1120 may include, but are not limited to, any type of volatile, non-volatile, or semi-volatile memory such as random access memory (RAM), dynamic RAM (DRAM), static RAM (SRAM), synchronous DRAM (SDRAM), erasable programmable read-only memory (EPROM), electrically erasable programmable read-only memory (EEPROM), Flash memory, solid-state storage, phase change RAM (PRAM), resistive memory such as magnetoresistive random access memory (MRAM), etc., and may incorporate three-dimensional (3D) cross-point (XPOINT) memories from Intel® and Micron®. The memory/storage devices 1120 may also comprise persistent storage devices, which may be temporal and/or persistent storage of any type, including, but not limited to, non-volatile memory, optical, magnetic, and/or solid state mass storage, and so forth.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

### VI. Example Procedures

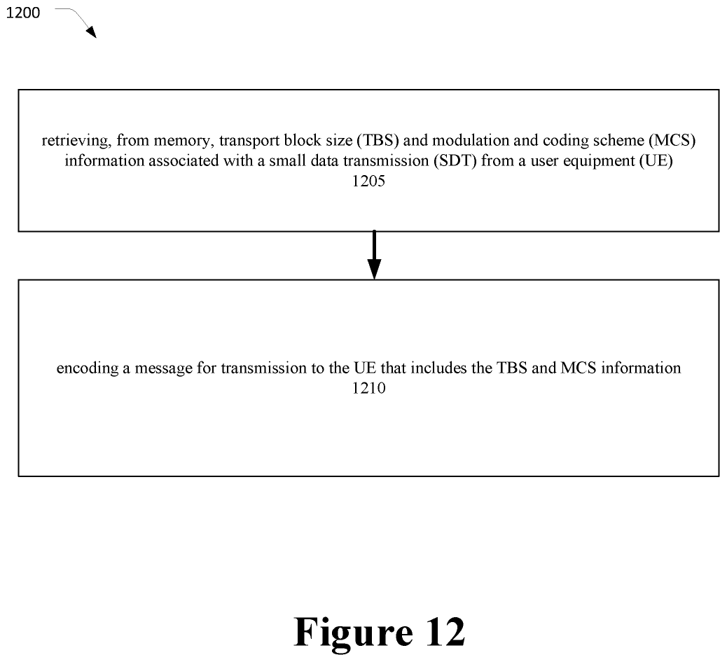

In some embodiments, the electronic device(s), network(s), system(s), chip(s) or component(s), or portions or implementations thereof, of FIGS. 9-11, or some other figure herein, may be configured to perform one or more processes, techniques, or methods as described herein, or portions thereof. One such process is depicted in FIG. 12.

For example, the process 1200 may include, at 1205, retrieving, from memory, transport block size (TBS) and modulation and coding scheme (MCS) information associated with a small data transmission (SDT) for a user equipment (UE). The process further includes, at 1210, encoding a message for transmission to the UE that includes the TBS and MCS information. For example, in some embodiments a UE selects PRACH preambles from group A or group B to indicate the TBS and/or MCS value for the transmission of Msg3 PUSCH or MsgA PUSCH.

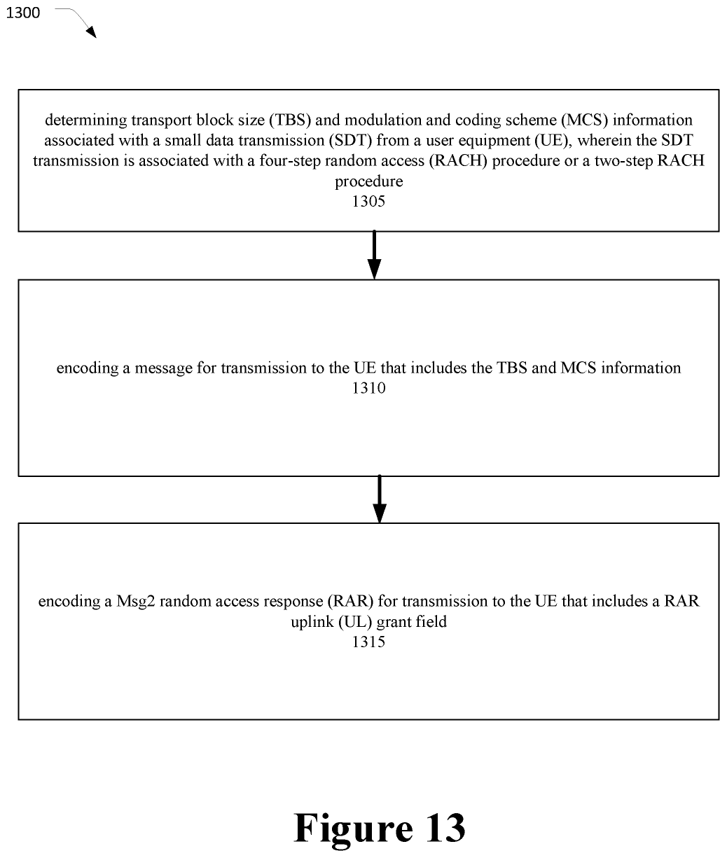

FIG. 13 illustrates another process in accordance with various embodiments. In this example, the process 1300 includes, at 1305, determining transport block size (TBS) and modulation and coding scheme (MCS) information associated with a small data transmission (SDT) from a user equipment (UE), wherein the SDT transmission is associated with a four-step random access (RACH) procedure or a two-step RACH procedure. The process further includes, at 1310, encoding a message for transmission to the UE that includes the TBS and MCS information. The process further includes, at 1315, encoding a Msg2 random access response (RAR) for transmission to the UE that includes a RAR uplink (UL) grant field.

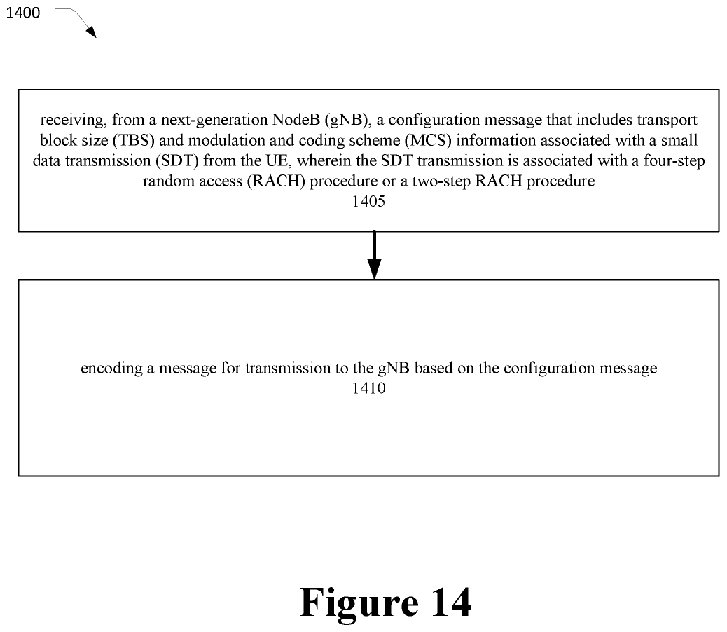

FIG. 14 illustrates another process in accordance with various embodiments. In this example, the process 1400 includes, at 1405, receiving, from a next-generation NodeB (gNB), a configuration message that includes transport block size (TBS) and modulation and coding scheme (MCS) information associated with a small data transmission (SDT) from the UE, wherein the SDT transmission is associated with a four-step random access (RACH) procedure or a two-step RACH procedure. The process further includes, at 1410, encoding a message for transmission to the gNB based on the configuration message.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### VII. EXAMPLES

Additional examples of the presently described embodiments include the following, non-limiting implementations. Each of the following non-limiting examples may stand on its own or may be combined in any permutation or combination with any one or more of the other examples provided below or throughout the present disclosure.

Example A01 includes a method of wireless communication for a fifth generation (5G) or new radio (NR) system, the method comprising: configuring, by a gNodeB (gNB), a small data transmission (SDT) on message 3 (Msg3) using a 4-step random access (RACH) procedure and/or message A (MsgA) PUSCH using a 2-step RACH procedure; and transmitting, by a UE, the Msg3 in the 4-step RACH and/or the MsgA PUSCH in the 2-step RACH in accordance with the SDT.

Example A02 includes the method of example A01 and/or some other example(s) herein, wherein for SDT during 4-step and/or 2-step RACH procedure, the UE may transmit Msg.3 and/or MsgA PUSCH in accordance with a transport block size (TBS)/modulation and coding scheme (MCS) from a set of TBS/MCS values which are configured by higher layers via NR remaining minimum system information (RMSI), NR other system information (OSI) or dedicated radio resource control (RRC) signalling.

Example A03 includes the method of example A01 and/or some other example(s) herein, wherein the set of TBS/MCS values may be configured for preamble group A and B, respectively and UE selects a group in which the set of TBS/MCS values can handle the Msg3/MsgA payload size.

Example A04 includes the method of example A03 and/or some other example(s) herein, wherein for SDT during 4-step RACH procedure, RAR UL grant may indicate more than one Msg3 PUSCH frequency domain resource allocation (FDRA) and/or time domain resource allocation (TDRA).

Example A05 includes the method of example A01 and/or some other example(s) herein, wherein for SDT during 4-step RACH procedure, RAR UL grant may indicate a single Msg3 PUSCH FDRA and TDRA; wherein MCS field in the UL grant may be reserved.

Example A06 includes the method of example A05 and/or some other example(s) herein, wherein a set of MCS values for Msg3 transmission may be configured by higher layers via minimum system information (MSI), remaining minimum system information (RMSI), other system information (OSI) and/or dedicated radio resource control (RRC) signalling.

Example A07 includes the method of example A05 and/or some other example(s) herein, wherein based on the indicated FDRA and TDRA in the RAR UL grant, UE can derive a set of TBSs in accordance with the set of MCS values configured by higher layers associated with the preamble group, wherein if the payload size is less than one smallest TBS (denoted as TBS_A), UE would perform zero padding and select the MCS from the set of MCS values which corresponds to TBS_A for the transmission of Msg3 PUSCH.

Example A08 includes the method of example A05 and/or some other example(s) herein, wherein MCS in RAR grant field for SDT with 4-step RACH procedure may be used to indicate the maximum MCS index that UE can use for Msg3 PUSCH transmission from the set of configured MCS values.

Example A09 includes the method of example A01 and/or some other example(s) herein, wherein for SDT during 4-step RACH procedure, RAR UL grant may be used to indicate a single Msg3 PUSCH FDRA and TDRA, which corresponds to a maximum resource allocation for Msg3 transmission; wherein When a set of TBSs can be used for Msg3 transmission, and when the payload size is less than the one smallest TBS, UE may use indicated MCS and a subset of allocated resource for Msg3 transmission.

Example A10 includes the method of example A01 and/or some other example(s) herein, wherein the above embodiments for RAR UL grant can be straightforwardly applied for fallbackRAR UL grant for Msg3 transmission.

Example A11 includes the method of example A01 and/or some other example(s) herein, wherein a UE may be configured with more than one DMRS resources for transmission of Msg3 for 4-step RACH and/or MsgA PUSCH for 2-step RACH, wherein the UE may transmit the DMRS in one of the DMRS resources in accordance with the TBS/MCS for Msg3 for 4-step RACH and/or MsgA PUSCH for 2-step RACH.

Example A12 includes the method of example A01 and/or some other example(s) herein, wherein when UE transmits DMRS in a first DMRS resource, it can be used to indicate a first TBS/MCS for transmission of Msg3 for 4-step RACH and/or MsgA PUSCH for 2-step RACH; wherein when UE transmits DMRS in a second DMRS resource, it can be used to indicate a second TBS/MCS for transmission of Msg3 for 4-step RACH and/or MsgA PUSCH for 2-step RACH.

Example A13 includes the method of example A01 and/or some other example(s) herein, wherein for SDT during 4-step RACH procedure, one field in the random access response (RAR) may be repurposed or some states in one or more existing fields in the RAR may be reserved and repurposed to indicate the fallback mechanism from SDT to legacy 4-step RACH procedure.

Example A14 includes the method of example A01 and/or some other example(s) herein, wherein after UE transmits the MsgA PUSCH, gNB may indicate UE to fallback to 4-step RACH with and without SDT.

Example A15 includes the method of example A14 and/or some other example(s) herein, wherein one or more fields in the fallbackRAR may be repurposed or some states in one or more fields in the fallbackRAR may be reserved to indicate the fallback mechanism from SDT using 2-step RACH to 4-step RACH procedure with and without SDT.

Example A16 includes the method of example A14 and/or some other example(s) herein, wherein reserved field “R” in the fallbackRAR can be set to ‘1’ indicate the fallback to 4-step RACH with SDT.

Example A17 includes the method of example A14 and/or some other example(s) herein, wherein some states in one or more fields in the RAR may be reserved to indicate the fallback to 4-step RACH procedure with or without SDT.

Example A18 includes the method of example A01 and/or some other example(s) herein, wherein different fallbackRAR can be considered, one for non-SDT (e.g., using the legacy fallbackRAR) and another for SDT (e.g., introducing a new SDT fallback RAR), wherein the differentiation of this can be indicated in the subheader for the RAR.

Example B01 includes a method comprising: performing a Type-1 or Type-2 random access procedure wherein a small data transmission (SDT) is included in a message communicated during the Type-1 or Type-2 random access procedure.

Example B02 includes the method of example B01 and/or some other example(s) herein, wherein the SDT indicates a transport block size (TBS) or a modulation and coding scheme (MCS).

Example B03 includes the method of examples B01-B02 and/or some other example(s) herein, further comprising: transmitting a Msg.3 and/or MsgA PUSCH in accordance with a TBS/MCS from a set of TBS/MCS values that are configured by higher layers via NR remaining minimum system information (RMSI), NR other system information (OSI), or radio resource control (RRC) signalling.

Example B03 includes the method of examples B01-B02 and/or some other example(s) herein, wherein a random access response (RAR) uplink (UL) grant indicates more than one Msg3 PUSCH frequency domain resource allocations (FDRAs) and/or time domain resource allocations (TDRAs), and the method further comprises: deriving, based on an indicated MCS in the RAR UL, one or more TBSs in accordance with the indicated FDRAs and TDRAs.

Example B04 includes the method of example B03 and/or some other example(s) herein, further comprising: when the Msg.3 payload size is less than one of the derived TBSs for the FDRA and TDRA to transmit Msg3, performing zero padding to match with the derived TBS and select the corresponding FDRA and TDRA for Msg3 PUSCH transmission.

Example B05 includes the method of examples B01-B02 and/or some other example(s) herein, wherein the RAR UL grant indicates a single Msg3 PUSCH FDRA and TDRA, and an MCS field in the RAR UL grant is reserved, which indicates to ignore this field for Msg3 PUSCH transmission.

Example B06 includes the method of example B05 and/or some other example(s) herein, wherein a set of MCS values for Msg3 transmission is configured by higher layers via MSI, RMSI, OSI, and/or RRC signalling.

Example B07 includes the method of example B06 and/or some other example(s) herein, wherein the set of MCS values is configured per preamble group A, per preamble group B, or both preamble groups A and B.

Example B08 includes the method of example B07 and/or some other example(s) herein, further comprising: deriving, based on the indicated FDRA and TDRA in the RAR UL grant, a set of TBSs in accordance with the set of MCS values configured by the higher layers associated with the preamble group.

Example B09 includes the method of example B08 and/or some other example(s) herein, further comprising: when a payload size is less than a smallest TBS (TBS_A), performing zero padding, and selecting an MCS from the set of MCS values corresponding to the TBS_A for the transmission of the Msg3 PUSCH.

Example B10 includes the method of examples B01-B09 and/or some other example(s) herein, wherein an MCS in an RAR grant field for SDT with the Type-1 random access procedure indicates a maximum MCS index that can be used for Msg3 PUSCH transmission from a set of configured MCS values.

Example B11 includes the method of examples B01-B10 and/or some other example(s) herein, wherein, for SDT during the Type-1 random access procedure, the RAR UL grant indicates a single Msg3 PUSCH FDRA and TDRA, which corresponds to a maximum resource allocation for Msg3 transmission, and the RAR UL grant further indicates a maximum TBS that can be carried by the Msg3 PUSCH, which can be derived in accordance with the indicated FDRA and TDRA resource and MCS.

Example B12 includes the method of examples B01-B11 and/or some other example(s) herein, further comprising: when a set of TBSs can be used for Msg3 transmission, and when the payload size is less than the one smallest TBS, using an indicated MCS and a subset of allocated resources for the Msg3 transmission.

Example B13 includes the method of example B12 and/or some other example(s) herein, further comprising: deriving, using a set of scaling factors, the subset of allocated resources.

Example B14 includes the method of examples B01-B13 and/or some other example(s) herein, further comprising: for SDT with Type-2 random access procedure, performing a fallback mechanism to SDT with Type-1 random access procedure.

Example B15 includes the method of example B14 and/or some other example(s) herein, further comprising: using a fallbackRAR UL grant to indicate an MCS and resource(s) to be used for Msg3 transmission.

Example B16 includes the method of example B14 and/or some other example(s) herein, further comprising: transmitting one or more demodulation reference signals (DMRSs) over one or more configured DMRS resources for transmission of Msg3 for Type-1 random access procedure and/or MsgA PUSCH for Type-1 random access procedure, the transmitting being in accordance with the TBS/MCS for Msg3 for Type-1 random access procedure and/or MsgA PUSCH for Type-2 random access procedure.

Example B17 includes the method of example B16 and/or some other example(s) herein, further comprising: transmitting a first DMRS in a first DMRS resource to indicate a first TBS/MCS for transmission of Msg3 for Type-1 random access procedure and/or MsgA PUSCH for Type-2 random access procedure; and transmitting a second DMRS in a second DMRS resource to indicate a second TBS/MCS for transmission of Msg3 for Type-1 random access procedure and/or MsgA PUSCH for Type-2 random access procedure.

Example B17 includes the method of example B16 and/or some other example(s) herein, wherein, for SDT using Type-1 random access procedure, when CP-OFDM waveform is configured for the transmission of Msg3, more than one scrambling IDs are configured for Msg3 transmission by higher layers via RMSI (SIB1), OSI, or RRC signalling.

Example B18 includes the method of examples B16-B17 and/or some other example(s) herein, wherein, for SDT using Type-2 random access procedure, one to many mapping between MsgA PRACH preamble and PUSCH resource unit (PRU) may be defined.

Example B18A includes the method of examples B15-B17 and/or some other example(s) herein, wherein one or more fields in a fallbackRAR are repurposed to indicate a fallback mechanism.

Example B19 includes the method of examples B15-B18 and/or some other example(s) herein, wherein one or more states (or values) in one or more fields in a fallbackRAR are used to indicate the fallback mechanism from SDT using Type-2 random access procedure to Type-1 random access procedure with and without SDT.

Example B20 includes the method of example B19 and/or some other example(s) herein, wherein a reserved field “R” in the fallbackRAR is set to ‘1’ indicate a fallback to the Type-1 random access procedure with SDT, wherein a default state or ‘0’ value indicate sthe fallback to Type-1 random access procedure without SDT.

Example B21 includes the method of examples B19-B20 and/or some other example(s) herein, wherein a reserved field “R” in the fallbackRAR is set to ‘1’ indicate a fallback to the Type-1 random access procedure without EDT, wherein a default state or ‘0’ value indicate sthe fallback to Type-1 random access procedure with EDT.

Example B22 includes the method of examples B01-B21 and/or some other example(s) herein, wherein the method is performed by a user equipment (UE) or a next generation NodeB (gNB).

Example X1 includes an apparatus comprising:
memory to store transport block size (TBS) and modulation and coding scheme (MCS) information associated with a small data transmission (SDT) from a user equipment (UE); and
processing circuitry, coupled with the memory, to:
   retrieve the TBS and MCS information from the memory; and
   encode a message for transmission to the UE that includes the TBS and MCS information.

Example X2 includes the apparatus of example X1 or some other example herein, wherein the SDT transmission is associated with a four-step random access (RACH) procedure or a two-step RACH procedure.

Example X3 includes the apparatus of example X2 or some other example herein, wherein the processing circuitry is further to encode a Msg2 random access response (RAR) for transmission to the UE that includes a RAR uplink (UL) grant field.

Example X4 includes the apparatus of example X3 or some other example herein, wherein the RAR UL grant field indicates a plurality of Msg3 PUSCH frequency domain resource allocations (FDRAs), or a plurality of time domain resource allocations (TDRAs).

Example X5 includes the apparatus of example X3 or some other example herein, wherein the RAR UL grant field indicates a single Msg3 PUSCH FDRA and a single Msg3 PUSCH TDRA.

Example X6 includes the apparatus of example X3 or some other example herein, wherein the RAR UL grant field includes a reserved MCS field to indicate that the UE is to ignore the MCS field for Msg3 PUSCH transmission.

Example X7 includes the apparatus of example X3 or some other example herein, wherein the RAR UL grant field includes an MCS field to indicate a maximum MCS index that the UE can use for Msg3 PUSCH transmission from a set of MCS values in the TBS and MCS information.

Example X8 includes the apparatus of any of examples X1-X7 or some other example herein, wherein the processing circuitry is further to select PRACH preambles from group A or group B to indicate a TBS or MCS value for transmission of Msg3 PUSCH or MsgA PUSCH.

Example X9 includes the apparatus of any of examples X1-X8, wherein the SDT transmission from the UE is associated with a Msg3 transmission or a MsgA physical uplink shared channel (PUSCH) transmission.

Example X10 includes the apparatus of any of examples X1-X9, wherein the message is encoded for transmission to the UE via new radio (NR) remaining minimum system information (RMSI), NR other system information (OSI), or dedicated radio resource control (RRC) signaling.

Example X11 includes one or more computer-readable media storing instructions that, when executed by one or more processors, cause a next-generation NodeB (gNB) to:
determine transport block size (TBS) and modulation and coding scheme (MCS) information associated with a small data transmission (SDT) from a user equipment (UE), wherein the SDT transmission is associated with a four-step random access (RACH) procedure or a two-step RACH procedure;
encode a message for transmission to the UE that includes the TBS and MCS information; and
encode a Msg2 random access response (RAR) for transmission to the UE that includes a RAR uplink (UL) grant field.

Example X12 includes the one or more computer-readable media of example X11 or some other example herein, wherein the RAR UL grant field indicates a plurality of Msg3 PUSCH frequency domain resource allocations (FDRAs), or a plurality of time domain resource allocations (TDRAs).

Example X13 includes the one or more computer-readable media of example X11 or some other example herein, wherein the RAR UL grant field indicates a single Msg3 PUSCH FDRA and a single Msg3 PUSCH TDRA.

Example X14 includes the one or more computer-readable media of example X11 or some other example herein, wherein the RAR UL grant field includes a reserved MCS field to indicate that the UE is to ignore the MCS field for Msg3 PUSCH transmission.

Example X15 includes the one or more computer-readable media of example X11 or some other example herein, wherein the RAR UL grant field includes an MCS field to indicate a maximum MCS index that the UE can use for Msg3 PUSCH transmission from a set of MCS values in the TBS and MCS information.

Example X16 includes the one or more computer-readable media of any of examples X11-X15, wherein the TBS and MCS information includes values configured for preamble group A or preamble group B.

Example X17 includes the one or more computer-readable media of any of examples X11-X16, wherein the message is encoded for transmission to the UE via new radio (NR) remaining minimum system information (RMSI), NR other system information (OSI), or dedicated radio resource control (RRC) signaling.

Example X18 includes one or more computer-readable media storing instructions that, when executed by one or more processors, cause a user equipment (UE) to:
receive, from a next-generation NodeB (gNB), a configuration message that includes transport block size (TBS) and modulation and coding scheme (MCS) information associated with a small data transmission (SDT) from the UE, wherein the SDT transmission is associated with a four-step random access (RACH) procedure or a two-step RACH procedure; and
encode a message for transmission to the gNB based on the configuration message.

Example X19 includes the one or more computer-readable media of example X18 or some other example herein, wherein the message is a Msg3 message or a MsgA PUSCH message.

Example X20 includes the one or more computer-readable media of example X18 or some other example herein, wherein the RAR UL grant field indicates:
a plurality of Msg3 PUSCH frequency domain resource allocations (FDRAs); or
a plurality of time domain resource allocations (TDRAs); or
a single Msg3 PUSCH FDRA and a single Msg3 PUSCH TDRA.

Example X21 includes the one or more computer-readable media of example X20 or some other example herein, wherein the media further stores instructions for causing the UE to derive one or more TBSs based on the configuration message and the FDRAs or TDRAs indicated in the RAR UL grant field.

Example X22 includes the one or more computer-readable media of example X18 or some other example herein, wherein:
the RAR UL grant field includes a reserved MCS field to indicate that the UE is to ignore the MCS field for Msg3 PUSCH transmission; or
the RAR UL grant field includes an MCS field to indicate a maximum MCS index that the UE can use for Msg3 PUSCH transmission from a set of MCS values in the TBS and MCS information.

Example X23 includes the one or more computer-readable media of any of examples X18-X22 or some other example herein, wherein the media further stores instructions for causing the UE to select PRACH preambles from group A or group B to indicate a TBS or MCS value for transmission of Msg3 PUSCH or MsgA PUSCH.

Example Z01 includes an apparatus comprising means to perform one or more elements of a method described in or related to any of examples A01-A18, B01-B22, X1-X23, or any other method or process described herein.

Example Z02 includes one or more non-transitory computer-readable media comprising instructions to cause an electronic device, upon execution of the instructions by one or more processors of the electronic device, to perform one or more elements of a method described in or related to any of examples A01-A18, B01-B22, X1-X23, or any other method or process described herein.

Example Z03 includes an apparatus comprising logic, modules, or circuitry to perform one or more elements of a method described in or related to any of examples A01-A18, B01-B22, X1-X23, or any other method or process described herein.

Example Z04 includes a method, technique, or process as described in or related to any of examples A01-A18, B01-B22, X1-X23, or portions or parts thereof.

Example Z05 includes an apparatus comprising: one or more processors and one or more computer-readable media comprising instructions that, when executed by the one or more processors, cause the one or more processors to perform the method, techniques, or process as described in or related to any of examples A01-A18, B01-B22, X1-X23, or portions thereof.

Example Z06 includes a signal as described in or related to any of examples A01-A18, B01-B22, X1-X23, or portions or parts thereof.

Example Z07 includes a datagram, packet, frame, segment, protocol data unit (PDU), or message as described in or related to any of examples A01-A18, B01-B22, X1-X23, or portions or parts thereof, or otherwise described in the present disclosure.

Example Z08 includes a signal encoded with data as described in or related to any of examples A01-A18, B01-B22, X1-X23, or portions or parts thereof, or otherwise described in the present disclosure.

Example Z09 includes a signal encoded with a datagram, packet, frame, segment, protocol data unit (PDU), or message as described in or related to any of examples A01-A18, B01-B22, X1-X23, or portions or parts thereof, or otherwise described in the present disclosure.

Example Z10 includes an electromagnetic signal carrying computer-readable instructions, wherein execution of the computer-readable instructions by one or more processors is to cause the one or more processors to perform the method, techniques, or process as described in or related to any of examples A01-A18, B01-B22, X1-X23, or portions thereof.

Example Z11 includes a computer program comprising instructions, wherein execution of the program by a processing element is to cause the processing element to carry out the method, techniques, or process as described in or related to any of examples A01-A18, B01-B22, X1-X23, or portions thereof.

Example Z12 includes a signal in a wireless network as shown and described herein.

Example Z13 includes a method of communicating in a wireless network as shown and described herein.

Example Z14 includes a system for providing wireless communication as shown and described herein.

Example Z15 includes a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### IX. TERMINOLOGY

For the purposes of the present document, the following terms and definitions are applicable to the examples and embodiments discussed herein.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource. The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, the term “edge computing” refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership). As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” or “edge computing network” generally refer to a distributed architecture, organization, or collection of multiple nodes and devices, and which is organized to accomplish or offer some aspect of services or resources in an edge computing setting.

The term “Internet of Things” or “IoT” refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. “Edge IoT devices” may be any kind of IoT devices deployed at a network's edge.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The terms “instantiate,” “instantiation,” and the like as used herein refers to the creation of an instance. An “instance” also refers to a concrete occurrence of an object, which may occur, for example, during execution of program code.

The term “information element” refers to a structural element containing one or more fields. The term “field” refers to individual contents of an information element, or a data element that contains content.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

As used herein, the term “radio technology” refers to technology for wireless transmission and/or reception of electromagnetic radiation for information transfer. The term “radio access technology” or “RAT” refers to the technology used for the underlying physical connection to a radio based communication network.

As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

### X. ABBREVIATIONS

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
ACK Acknowledgement
AF Application Function
AM Acknowledged Mode
AMBR Aggregate Maximum Bit Rate
AMF Access and Mobility Management Function
AN Access Network
ANR Automatic Neighbour Relation
AP Application Protocol, Antenna Port,
Access Point
API Application Programming Interface
APN Access Point Name
ARP Allocation and Retention Priority
ARQ Automatic Repeat Request
AS Access Stratum
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary
Identity
CA Carrier Aggregation, Certification
Authority
CAPEX CAPital EXpenditure
CBRA Contention Based Random Access
CC Component Carrier, Country Code,
Cryptographic Checksum
CCA Clear Channel Assessment
CCE Control Channel Element
CCCH Common Control Channel
CE Coverage Enhancement
CDM Content Delivery Network
CDMA Code-Division Multiple Access
CFRA Contention Free Random Access
CG Cell Group
CI Cell Identity
CID Cell-ID (e.g., positioning method)
CIM Common Information Model
CIR Carrier to Interference Ratio
CK Cipher Key
CM Connection Management, Conditional
Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection
Point
CPD Connection Point Descriptor
CPE Customer Premise Equipment
CPICH Common Pilot Channel
CQI Channel Quality Indicator
CPU CSI processing unit, Central Processing
Unit
C/R Command/Response field bit
CRAN Cloud Radio Access Network, Cloud RAN
CRB Common Resource Block
CRC Cyclic Redundancy Check
CRI Channel-State Information Resource
Indicator, CSI-RS Resource Indicator
C-RNTI Cell RNTI
CS Circuit Switched
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference
ratio
CSMA Carrier Sense Multiple Access
CSMA/CA CSMA with collision avoidance
CSS Common Search Space, Cell-specific
Search Space
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DRB Data Radio Bearer
DRS Discovery Reference Signal
DRX Discontinuous Reception
DSL Domain Specific Language. Digital
Subscriber Line
DSLAM DSL Access Multiplexer
DwPTS Downlink Pilot Time Slot
E-LAN Ethernet Local Area Network
E2E End-to-End
ECCA extended clear channel assessment,
extended CCA
ECCE Enhanced Control Channel Element,
Enhanced CCE
ED Energy Detection
EDGE Enhanced Datarates for GSM Evolution
(GSM Evolution)
EGMF Exposure Governance Management Function
EGPRS Enhanced GPRS
EIR Equipment Identity Register
eLAA enhanced Licensed Assisted Access,
enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical
Downlink Control Cannel
EPRE Energy per resource element
EPS Evolved Packet System
EREG enhanced REG, enhanced resource
element groups
ETSI European Telecommunications
Standards Institute
ETWS Earthquake and Tsunami Warning System
eUICC embedded UICC, embedded Universal
Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMA Frequency Division Multiple Access
FDRA Frequency Domain Resource Allocation
FE Front End
FEC Forward Error Correction
FFS For Further Study
FFT Fast Fourier Transformation
feLAA further enhanced Licensed Assisted Access,
further enhanced LAA
FN Frame Number
FPGA Field-Programmable Gate Array
FR Frequency Range
G-RNTI GERAN Radio Network Temporary Identity
GERAN GSM EDGE RAN, GSM EDGE Radio Access Network
GGSN Gateway GPRS Support Node
GLONASS GLObal'naya NAvigatsionnaya
Sputnikovaya Sistema (Engl.: Global Navigation
Satellite System)
gNB Next Generation NodeB
gNB-CU gNB-centralized unit, Next Generation
NodeB centralized unit
gNB-DU gNB-distributed unit, Next Generation
NodeB distributed unit
GNSS Global Navigation Satellite System
GPRS General Packet Radio Service
GSM Global System for Mobile Communications,
Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics
Engineers
IEI Information Element Identifier
IEIDL Information Element Identifier Data Length
IETF Internet Engineering Task Force
IF Infrastructure
IM Interference Measurement, Intermodulation,
IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN Constraint length of the
convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec
Tunnel
LTE Long Term Evolution
M2M Machine-to-Machine
MAC Medium Access Control (protocol layering context)
MAC Message authentication code (security/encryption
context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service Single
Frequency Network
MCC Mobile Country Code
MCG Master Cell Group
MCOT Maximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information
Base
MIMO Multiple Input Multiple Output
MLC Mobile Location Centre
MM Mobility Management
MME Mobility Management Entity
MN Master Node
MnS Management Service
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information, MCH Scheduling
Information
MSID Mobile Station Identifier
MSIN Mobile Station Identification Number
MSISDN Mobile Subscriber ISDN Number
MT Mobile Terminated, Mobile Termination
MTC Machine-Type Communications
mMTC massive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non-Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAI Network Slice Selection Assistance Information
S-NNSAI Single-NSSAI
NSSF Network Slice Selection Function
NW Network
NWUS Narrowband wake-up signal, Narrowband WUS
NZP Non-Zero Power
O&M Operation and Maintenance
ODU2 Optical channel Data Unit - type 2
OFDM Orthogonal Frequency Division Multiplexing
OFDMA Orthogonal Frequency Division Multiple Access
OOB Out-of-band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol, Packet
Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSFCH Physical Sidelink Feedback Channel
PSSCH Physical Sidelink Shared Channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quaternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System
Information
RN Relay Node
RNC Radio Network Controller
RNL Radio Network Layer
RNTI Radio Network Temporary Identifier
ROHC RObust Header Compression
RRC Radio Resource Control, Radio Resource
Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SC-FDMA Single Carrier Frequency Division
Multiple Access
SCG Secondary Cell Group
SCM Security Context Management
SCS Subcarrier Spacing
SCTP Stream Control Transmission Protocol
SDAP Service Data Adaptation Protocol, Service Data
Adaptation Protocol layer
SDL Supplementary Downlink
SDNF Structured Data Storage Network Function
SDP Session Description Protocol
SDSF Structured Data Storage Function
SDU Service Data Unit
SEAF Security Anchor Function
SeNB secondary eNB
SEPP Security Edge Protection Proxy
SFI Slot format indication
SFTD Space-Frequency Time Diversity, SFN and
frame timing difference
SFN System Frame Number or Single Frequency Network
SgNB Secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTI Semi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB SS Block
SSBRI SSB Resource Indicator
SSC Session and Service Continuity
SS-RSRP Synchronization Signal based Reference
Signal Received Power
SS-RSRQ Synchronization Signal based Reference
Signal Received Quality
SS-SINR Synchronization Signal based Signal to
Noise and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAU Tracking Area Update
TB Transport Block
TBS Transport Block Size
TBD To Be Defined
TCI Transmission Configuration Indicator
TCP Transmission Communication Protocol
TDD Time Division Duplex
TDRA Time Domain Resource Allocation
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
UDR Unified Data Repository
UDSF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over-Internet Protocol
VPLMN Visited Public Land Mobile Network
VPN Virtual Private Network
VRB Virtual Resource Block
WiMAX Worldwide Interoperability for Microwave
Access
WLAN Wireless Local Area Network
WMAN Wireless Metropolitan Area Network
WPAN Wireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

1-23. (canceled)

24. An apparatus comprising:
memory to store transport block size (TBS) and modulation and coding scheme (MCS) information associated with a small data transmission (SDT) from a user equipment (UE); and
processing circuitry, coupled with the memory, to:
retrieve the TBS and MCS information from the memory; and
encode a message for transmission to the UE that includes the TBS and MCS information.

25. The apparatus of claim 24, wherein the SDT transmission is associated with a four-step random access (RACH) procedure or a two-step RACH procedure.

26. The apparatus of claim 25, wherein the processing circuitry is further to encode a Msg2 random access response (RAR) for transmission to the UE that includes a RAR uplink (UL) grant field.

27. The apparatus of claim 26, wherein the RAR UL grant field indicates a plurality of Msg3 PUSCH frequency domain resource allocations (FDRAs), or a plurality of time domain resource allocations (TDRAs).

28. The apparatus of claim 26, wherein the RAR UL grant field indicates a single Msg3 PUSCH FDRA and a single Msg3 PUSCH TDRA.

29. The apparatus of claim 26, wherein the RAR UL grant field includes a reserved MCS field to indicate that the UE is to ignore the MCS field for Msg3 PUSCH transmission.

30. The apparatus of claim 26, wherein the RAR UL grant field includes an MCS field to indicate a maximum MCS index that the UE can use for Msg3 PUSCH transmission from a set of MCS values in the TBS and MCS information.

31. The apparatus of claim 24, wherein the processing circuitry is further to select PRACH preambles from group A or group B to indicate a TBS or MCS value for transmission of Msg3 PUSCH or MsgA PUSCH.

32. The apparatus of claim 24, wherein the SDT transmission from the UE is associated with a Msg3 transmission or a MsgA physical uplink shared channel (PUSCH) transmission.

33. The apparatus of claim 24, wherein the message is encoded for transmission to the UE via new radio (NR) remaining minimum system information (RMSI), NR other system information (OSI), or dedicated radio resource control (RRC) signaling.

34. One or more non-transitory computer-readable media storing instructions that, when executed by one or more processors, cause a next-generation NodeB (gNB) to:
determine transport block size (TBS) and modulation and coding scheme (MCS) information associated with a small data transmission (SDT) from a user equipment (UE), wherein the SDT transmission is associated with a four-step random access (RACH) procedure or a two-step RACH procedure;
encode a message for transmission to the UE that includes the TBS and MCS information; and
encode a Msg2 random access response (RAR) for transmission to the UE that includes a RAR uplink (UL) grant field.

35. The one or more non-transitory computer-readable media of claim 34, wherein the RAR UL grant field indicates a plurality of Msg3 PUSCH frequency domain resource allocations (FDRAs), or a plurality of time domain resource allocations (TDRAs).

36. The one or more non-transitory computer-readable media of claim 34, wherein the RAR UL grant field indicates a single Msg3 PUSCH FDRA and a single Msg3 PUSCH TDRA.

37. The one or more computer-readable media of claim 34, wherein the RAR UL grant field includes a reserved MCS field to indicate that the UE is to ignore the MCS field for Msg3 PUSCH transmission.

38. The one or more non-transitory computer-readable media of claim 34, wherein the RAR UL grant field includes an MCS field to indicate a maximum MCS index that the UE can use for Msg3 PUSCH transmission from a set of MCS values in the TBS and MCS information.

39. The one or more non-transitory computer-readable media of claim 34, wherein the TBS and MCS information includes values configured for preamble group A or preamble group B.

40. The one or more non-transitory computer-readable media of claim 34, wherein the message is encoded for transmission to the UE via new radio (NR) remaining minimum system information (RMSI), NR other system information (OSI), or dedicated radio resource control (RRC) signaling.

41. One or more non-transitory computer-readable media storing instructions that, when executed by one or more processors, cause a user equipment (UE) to:
receive, from a next-generation NodeB (gNB), a configuration message that includes transport block size (TBS) and modulation and coding scheme (MCS) information associated with a small data transmission (SDT) from the UE, wherein the SDT transmission is associated with a four-step random access (RACH) procedure or a two-step RACH procedure; and
encode a message for transmission to the gNB based on the configuration message.

42. The one or more non-transitory computer-readable media of claim 41, wherein the message is a Msg3 message or a MsgA PUSCH message.

43. The one or more non-transitory computer-readable media of claim 41, wherein the RAR UL grant field indicates:
a plurality of Msg3 PUSCH frequency domain resource allocations (FDRAs); or
a plurality of time domain resource allocations (TDRAs); or
a single Msg3 PUSCH FDRA and a single Msg3 PUSCH TDRA.

44. The one or more non-transitory computer-readable media of claim 43, wherein the media further stores instructions for causing the UE to derive one or more TBSs based on the configuration message and the FDRAs or TDRAs indicated in the RAR UL grant field.

45. The one or more non-transitory computer-readable media of claim 41, wherein:
the RAR UL grant field includes a reserved MCS field to indicate that the UE is to ignore the MCS field for Msg3 PUSCH transmission; or
the RAR UL grant field includes an MCS field to indicate a maximum MCS index that the UE can use for Msg3 PUSCH transmission from a set of MCS values in the TBS and MCS information.

46. The one or more non-transitory computer-readable media of claim 41, wherein the media further stores instructions for causing the UE to select PRACH preambles from group A or group B to indicate a TBS or MCS value for transmission of Msg3 PUSCH or MsgA PUSCH.
